(19) United States
(12) Patent Application Publication
(10) Pub. No.: US 2023/0342677 A1
(43) Pub. Date: Oct. 26, 2023

(54) TASK OPTIMIZATION IN AN EXTENDED REALITY ENVIRONMENT

(71) Applicant: Meta Platforms Technologies, LLC, Menlo Park, CA (US)

(72) Inventors: Ruta Parimal DESAI, Mountlake Terrace, WA (US); Nitin Kamra, Redmond, WA (US)

(73) Assignee: Meta Platforms Technologies, LLC, Menlo Park, CA (US)

(21) Appl. No.: 18/305,003

(22) Filed: Apr. 21, 2023

Related U.S. Application Data
(60) Provisional application No. 63/363,438, filed on Apr. 22, 2022.

(51) Int. Cl. G06Q 10/06; G06V 20/50; G02B 27/01; G06T 19/00

(52) U.S. Cl. CPC G06Q 10/06311; G06V 20/50; G02B 27/017; G06T 19/006

(57) ABSTRACT

Techniques are provided for using a virtual assistant to optimize multi-step processes to enhance a user's ability and efficiency in performing tasks. In one particular aspect, a computer-implemented method is provided that includes obtaining input data from one or more cameras of a head-mounted device, detecting, from the input data, objects and relationships between the objects for performing a task, generating a symbolic task state based on the objects and the relationships between the objects, feeding, using a domain specific planning language, the symbolic task state and a corresponding desired task goal state into a planner, generating, using the planner, a plan that includes a sequence of actions to perform the task and achieve the corresponding desired task goal, and in response to executing the sequence of actions in the plan, rendering, on a display of the head-mounted device, virtual content in an extended reality environment.

### CROSS-REFERENCE TO RELATED APPLICATION

The present application is a non-provisional application of and claims the benefit and priority under 35 U.S.C. 119(e) of U.S. Provisional Application No. 63/363,438, filed Apr. 22, 2022, the entire contents of which is incorporated herein by reference for all purposes.

### FIELD

The present disclosure relates generally to task optimization in an extended reality environment, and more particularly, to techniques for using a virtual assistant to optimize multi-step processes to enhance a user's ability and efficiency in performing tasks.

### BACKGROUND

A virtual assistant is an artificial intelligence (AI) enabled software agent that can perform tasks or services including answer questions, provide information, play media, and provide an intuitive interface for connected devices such as smart home devices, for an individual based on voice or text utterances (e.g., commands or questions). Conventional virtual assistants process the words a user speaks or types and converts them into digital data that the software can analyze. The software uses a speech and/or text recognition-algorithm to find the most likely answer, solution to a problem, information, or command for a given task. As the number of utterances increase, the software learns over time what users want when they provide various utterances. This helps improve the reliability and speed of responses and services. In addition to their self-learning ability, their customizable features and scalability have led virtual assistants to gain popularity across various domain spaces including website chat, computing devices such as smart phones and automobiles, and as standalone passive listening devices.

Even though virtual assistants have proven to be a powerful tool, these domain spaces have proven to be an inappropriate venue for such a tool. The virtual assistant will continue to be an integral part in these domain spaces but will always likely be viewed as a complementary feature or limited use case, but not a crucial must have feature. Which is why more recently, developers having been looking for a better suited domain space for deploying virtual assistants. That domain space is extended reality. Extended reality is a form of reality that has been adjusted in some manner before presentation to a user, which may include, e.g., a virtual reality (VR), an augmented reality (AR), a mixed reality (MR), a hybrid reality, or some combination and/or derivatives thereof. Extended reality content may include completely generated virtual content or generated virtual content combined with physical content (e.g., physical or real-world objects). The extended reality content may include digital images or animation, video, audio, haptic feedback, or some combination thereof, and any of which may be presented in a single channel or in multiple channels (such as stereo video that produces a three-dimensional effect to the viewer). Extended reality may be associated with applications, products, accessories, services, or some combination thereof, that are, e.g., used to create content in an extended reality and/or used in (e.g., perform activities in) an extended reality. The extended reality system that provides such content may be implemented on various platforms, including a head-mounted display (HMD) connected to a host computer system, a standalone HMD, a mobile device or computing system, or any other hardware platform capable of providing extended reality content to one or more viewers.

However, extended reality headsets and devices are limited in the way users interact with applications. Some provide hand controllers, but controllers betray the point of freeing the user's hands and limit the use of extended reality headsets. Others have developed sophisticated hand gestures for interacting with the components of extended reality applications. Hand gestures are a good medium, but they have their limits. For example, given the limited field of view that extended reality headsets have, hand gestures require users to keep their arms extended so that they enter the active area of the headset's sensors. This can cause fatigue and again limit the use of the headset. This is why virtual assistants have become important as a new interface for extended reality devices such as headsets. Virtual assistants can easily blend in with all the other features that the extended reality devices provide to their users. Virtual assistants can help users accomplish tasks with their extended reality devices that previously required controller input or hand gestures on or in view of the extended reality devices. Users can use virtual assistants to open and close applications, activate features, or interact with virtual objects. When combined with other technologies such as eye tracking, virtual assistants can become even more useful. For instance, users can query for information about the object their staring at or ask the virtual assistant for assistance with performing tasks within the extended reality environment.

### BRIEF SUMMARY

Techniques disclosed herein relate generally to task optimization in an extended reality environment. More specifically and without limitation, techniques disclosed herein relate to using a virtual assistant to optimize multi-step processes to enhance a user's ability and efficiency in performing tasks. This is particularly applicable in instances where multiple tasks are to be performed simultaneously. Also disclosed are techniques for using a virtual assistant to allocate tasks in multi-step processes involving two or more users to enhance the collaborative effort between the users. For example, if two or more users are cooking based on various recipes, the tasks associated with each recipe may be allocated to the users based on skill level and/or to most efficiently complete the cooking.

In various embodiments, computer-implemented method is provided that comprises obtaining input data from one or more cameras of a head-mounted device, the input data including video captured by the one or more cameras; detecting, from the input data, objects and relationships between the objects for performing a task; generating a symbolic task state based on the objects and the relationships between the objects; feeding, using a domain specific planning language, the symbolic task state and a corresponding desired task goal state into a planner; generating, using the planner, a plan that includes a sequence of actions to perform the task and achieve the corresponding desired task goal, wherein the sequence of actions optimize for one or more metrics while respecting constraints, costs, and preferences for the task; and in response to executing the sequence of actions in the plan, rendering, on a display of the head-mounted device, virtual content in an extended reality environment.

In some embodiments, the input data further includes a request by the user for assistance in performing the task; the objects and relationships between the objects pertain to the task; and the corresponding desired task goal state is a state that the objects and the relationships between the objects must take in order for the task to be considered completed.

In some embodiments, the method further comprises identifying a planning model for the task from a corpus of planning models for various tasks, wherein the planning model for the task is expressed with the domain specific planning language, and wherein the planning model encodes the actions for the task and how the actions impact the objects and the relationships between the objects.

In some embodiments, detecting the objects and the relationships between the objects comprises extracting object features from the input data, locating a presence of the objects with a bounding box and assigning labels to types or classes of the located objects and relationships between the located objects based on the extracted object features, and wherein the labels for the located objects and the relationships between the located objects are a set of state variables that are propositional in nature for the symbolic task state as observed by the user, and generating the symbolic task state comprises describing an association of the objects and the relationships between the objects with the labels as logical statements.

In some embodiments, the rendering comprises: executing at least some of the sequence of actions in the plan, wherein the executing comprises determining virtual content data to be used for rendering the virtual content based on the sequence of actions, and wherein determining the virtual content data comprises mapping the actions to respective action spaces and determining the virtual content data associated with the respective action spaces; and rendering the virtual content in the extended reality environment displayed to the user based on the virtual content data.

In some embodiments, the virtual content presents instructions or recommendations to the user for performing at least some of the sequence of actions based on the plan.

In some embodiments, the input data includes: (i) data regarding activity of the user in the extended reality environment, (ii) data from external systems, or (iii) both, and the data regarding activity of the user includes the video.

In some embodiments, the input data is obtained from one or more cameras from each of a plurality of head-mounted devices including the headed-mounted device of the user; each of the plurality of headed-mounted devices comprises a display to display content to a different user and the one or more cameras to capture images of a visual field of the different user wearing the head-mounted device; the constraints include a requirement for allocating the actions from the sequence of actions amongst the user and each of the different users; and in response to executing the sequence of actions in the plan, the virtual content is rendered in the extended reality environment on the display of the user and each of the different users, and the virtual content rendered for the user and each of the different users is specific to the actions allocated for the user and each of the different users from the sequence of actions.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a network environment in accordance with various embodiments.

FIG. 2A an illustration depicting an example extended reality system that presents and controls user interface elements within an extended reality environment in accordance with various embodiments.

FIG. 2B an illustration depicting user interface elements in accordance with various embodiments.

FIG. 3A is an illustration of an augmented reality system in accordance with various embodiments.

FIG. 3B is an illustration of a virtual reality system in accordance with various embodiments.

FIG. 4A is an illustration of haptic devices in accordance with various embodiments.

FIG. 4B is an illustration of an exemplary virtual reality environment in accordance with various embodiments.

FIG. 4C is an illustration of an exemplary augmented reality environment in accordance with various embodiments.

FIG. 5 is a simplified block diagram of a virtual assistant in accordance with various embodiments.

FIG. 6 is an illustration of a planning problem in accordance with various embodiments.

FIG. 7 is block diagram for planning in an extended reality environment in accordance with various embodiments.

FIG. 8 is an illustration of associations between objects and object relationships in accordance with various embodiments.

FIGS. 9A and 9B are block diagrams for solving a plan and object detection in an extended reality environment in accordance with various embodiments.

FIGS. 10A and 10B are an illustration of an exemplary plan in accordance with various embodiments.

FIG. 11 is a flowchart illustrating a process for assisting users with performing an activity or achieving a goal in accordance with various embodiments.

FIG. 12 is an illustration of a planner allocating tasks to multiple players in accordance with various embodiments.

FIG. 13A is an illustration of user timelines in accordance with various embodiments.

FIG. 13B is an illustration of user spatial maps in accordance with various embodiments.

FIGS. 13C-13E show a two-dimensional visualization of two users coordinating their chores using the multiuser version of the task scheduler in accordance with various embodiments.

FIG. 14A is an illustration of user timelines in accordance with various embodiments.

FIG. 14B is an illustration of user discomforts in accordance with various embodiments.

FIG. 15A is an illustration of user timelines after a first re-planning in accordance with various embodiments.

FIG. 15B is an illustration of user timelines after a second re-planning in accordance with various embodiments.

FIG. 16 is a flowchart illustrating a process for assigning actions to assist users with performing a task and achieving a goal in accordance with various embodiments.

FIGS. 17A-17J show an actual three-dimensional demo of a user performing tasks using the task scheduler in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Extended reality systems are becoming increasingly ubiquitous with applications in many fields such as computer gaming, health and safety, industrial, and education. As a few examples, extended reality systems are being incorporated into mobile devices, gaming consoles, personal computers, movie theaters, and theme parks. Typical extended reality systems include one or more devices for rendering and displaying content to users. As one example, an extended reality system may incorporate a HMD worn by a user and configured to output extended reality content to the user. The extended reality content may be generated in a wholly or partially simulated environment (extended reality environment) that people sense and/or interact with via an electronic system. The simulated environment may be a VR environment, which is designed to be based entirely on computer-generated sensory inputs (e.g., virtual content) for one or more user senses, or a MR environment, which is designed to incorporate sensory inputs (e.g., a view of the physical surroundings) from the physical environment, or a representation thereof, in addition to including computer-generated sensory inputs (e.g., virtual content). Examples of MR include AR and augmented virtuality (AV). An AR environment is a simulated environment in which one or more virtual objects are superimposed over a physical environment, or a representation thereof, or a simulated environment in which a representation of a physical environment is transformed by computer-generated sensory information. An AV environment refers to a simulated environment in which a virtual or computer-generated environment incorporates one or more sensory inputs from the physical environment. In any instance—VR. MR, AR, or VR, during operation, the user typically interacts with the extended reality system to interact with extended reality content.

In many activities undertaken in our daily lives (e.g., chores, exercise, cooking, manufacturing, construction, etc.), numerous tasks are performed to accomplish a given goal (e.g., clean the house, cook a meal, construct a room, build a piece of furniture, repair an automobile, manufacture a product, etc.). However, humans have limited information processing capability, and the performance of these tasks can become fairly complex, thereby increasing the overall information that needs to be processed to perform the tasks and achieve the goal. In some of these activities there is also a desire to minimize or maximize one or more objectives while performing the tasks or achieving the goal (e.g., achieve the goal in a certain amount of time, perform the tasks in an efficient manner, achieve the goal with minimal cost, perform the tasks with the use of minimal resource consumption, achieve the goal within a certain degree of correctness or quality, etc.). However, more often than not the tempo and complex task interdependencies exceed people's cognitive capacity to manage the activity while optimizing the one or more objectives. Moreover, in some instances, there is a desire to undertake these activities using as a group of people (e.g., two or more users or workers). However, this adds in the complexity of allocating tasks to each of the people working together to perform the tasks and achieve the goal (especial when each person has a different skill set or experience level with the activity). Supporting users in using suitable assistance systems can reduce the information overload and complexity of tasks, maintain efficient processes, and prevent errors. Therefore, developing an interface that will assist users is important for supporting users in the performance and optimization of these activities.

In order overcome these challenges and others, techniques are disclosed herein for using a virtual assistant or conductor as a Contextualized Human Agent Interface (CHAI) to support activities undertaken by one or more users (also referred to herein as workers or players). The virtual assistant can provide support in a number of ways including:
Streamlined Preparation: The virtual assistant can compute the order of actions to complete single or multiple workflows (e.g., cook a single or multiple recipes and/or clean a single or multiple rooms) so that the user can accomplish workflow preparation and completion in the least amount of time and effort.
Multitasking: The virtual assistant can enable multitasking with another task or a set of tasks undertaking a given activity—for example cooking and cleaning simultaneously such that the tasks can be accomplished in the least amount of time and effort.
Multiuser Coordination: The virtual assistant can divide the subtasks for an activity comprised of a single or multiple workflow between multiple users who are performing the activity together such that the workflow(s) preparation and completion is achieved in the least amount of time and effort across all the users.
Collaboration: The virtual assistant can collaborate and support the user in an auxiliary task such as cleaning while the user performs their main task such as cooking as they wish.

In an exemplary embodiment, an extended reality system is provided that includes: a head-mounted device comprising a display to display content to a user and one or more cameras to capture images of a visual field of the user wearing the head-mounted device; one or more processors; and one or more memories accessible to the one or more processors, the one or more memories storing a plurality of instructions executable by the one or more processors, the plurality of instructions comprising instructions that when executed by the one or more processors cause the one or more processors to perform processing. The processing comprises: obtaining input data from the one or more cameras, the input data including video captured by the one or more cameras; detecting, from the input data, objects and relationships between the objects for performing a task; generating a symbolic task state based on the objects and the relationships between the objects; feeding, using a domain specific planning language, the symbolic task state and a corresponding desired task goal state into a planner; generating, using the planner, a plan that includes a sequence of actions to perform the task and achieve the corresponding desired task goal, where the sequence of actions optimize for one or more metrics while respecting constraints, costs, and preferences for the task; and in response to executing the sequence of actions in the plan, rendering, on the display, virtual content in an extended reality environment.

In another exemplary embodiment, a computer-implemented method is provided that includes obtaining input data from each of a plurality of users, where the input data includes a sequence of perceptions from a egocentric vision of each of the users; detecting, by an object detection model, objects and relationships between the objects within the input data of each user; generating a symbolic world state for the plurality of users based on the objects and relationships between the objects detected within the input data of each user; generating a domain specific planning language representation of a current domain and a problem based on the symbolic world state, where the current domain is associated with a scenario presented by at least one of the plurality of users and the scenario comprises a task to be performed and a goal to be achieved, and the problem comprises a temporal planning problem and a task allocation problem; generating a plan comprising a sequence of actions to perform the task and achieve the goal based on the domain specific planning language representation, where the generating the plan comprises solving the temporal planning problem and the task allocation problem for a sequence of actions that optimize for one or more metrics while respecting constraints, costs, and preferences for the current domain, and where the sequence of actions are a temporal ordering of the actions and each action is assigned to one or more of the plurality of users; executing the sequence of actions in the plan, where the executing comprises: determining virtual content data to be used for rendering virtual content based on the sequence of actions, and assigning the virtual content data to each user based on the assignment of each action to the one or more of the plurality of users; and rendering, by a client system associated with each user, the virtual content in an artificial reality environment displayed to each user based on the assignment of the virtual content data to each user. The virtual content presents, initiates, or executes actions from the sequence of actions for each of the plurality of users.

### Extended Reality System Overview

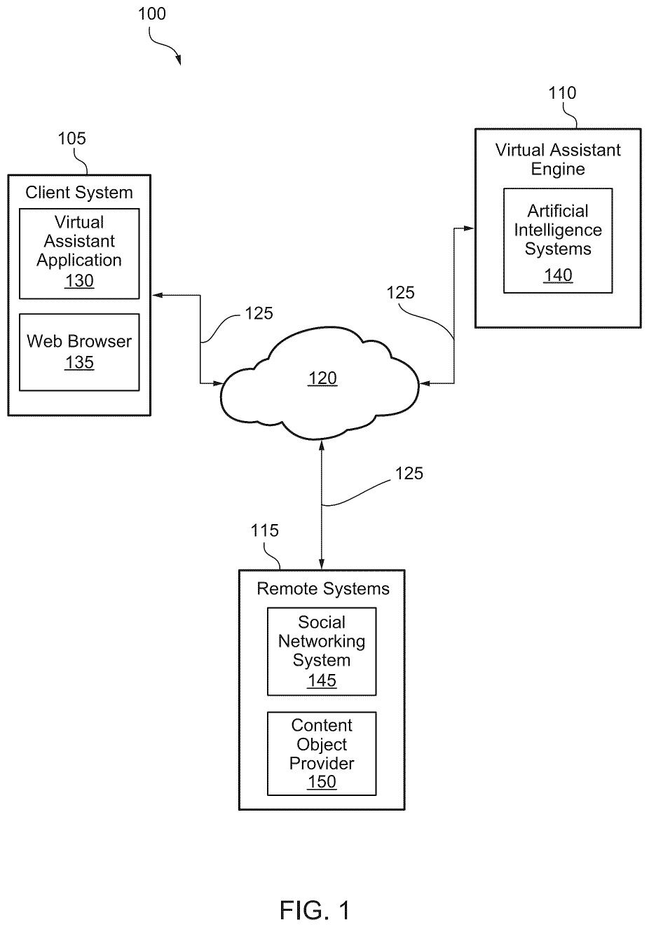

FIG. 1 illustrates an example network environment 100 associated with an extended reality system in accordance with aspects of the present disclosure. Network environment 100 includes a client system 105, a virtual assistant engine 110, and remote systems 115 connected to each other by a network 120. Although FIG. 1 illustrates a particular arrangement of a client system 105, a virtual assistant engine 110, remote systems 115, and a network 120, this disclosure contemplates any suitable arrangement of a client system 105, a virtual assistant engine 110, remote systems 115, and a network 120. As an example, and not by way of limitation, two or more of client systems 105, a virtual assistant engine 110, and a remote systems 115 may be connected to each other directly, bypassing the network 120. As another example, two or more of aa client system 105, a virtual assistant engine 110, and remote systems 115 may be physically or logically co-located with each other in whole or in part. Moreover, although FIG. 1 illustrates a particular number of a client system 105, a virtual assistant engine 110, remote systems 115, and networks 120, this disclosure contemplates any suitable number of client systems 105, virtual assistant engines 110, remote systems 115, and networks 120. As an example, and not by way of limitation, network environment 100 may include multiple client systems 105, virtual assistant engines 110, remote systems 115, and networks 115.

This disclosure contemplates any suitable network 120. As an example and not by way of limitation, one or more portions of a network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 120 may include one or more networks 120.

Links 125 may connect a client system 105, a virtual assistant engine 110, and a remote system 115 to a communication network 110 or to each other. This disclosure contemplates any suitable links 125. In particular embodiments, one or more links 125 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 125 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 125, or a combination of two or more such links 125. Links 125 need not necessarily be the same throughout a network environment 100. One or more first links 125 may differ in one or more respects from one or more second links 125.

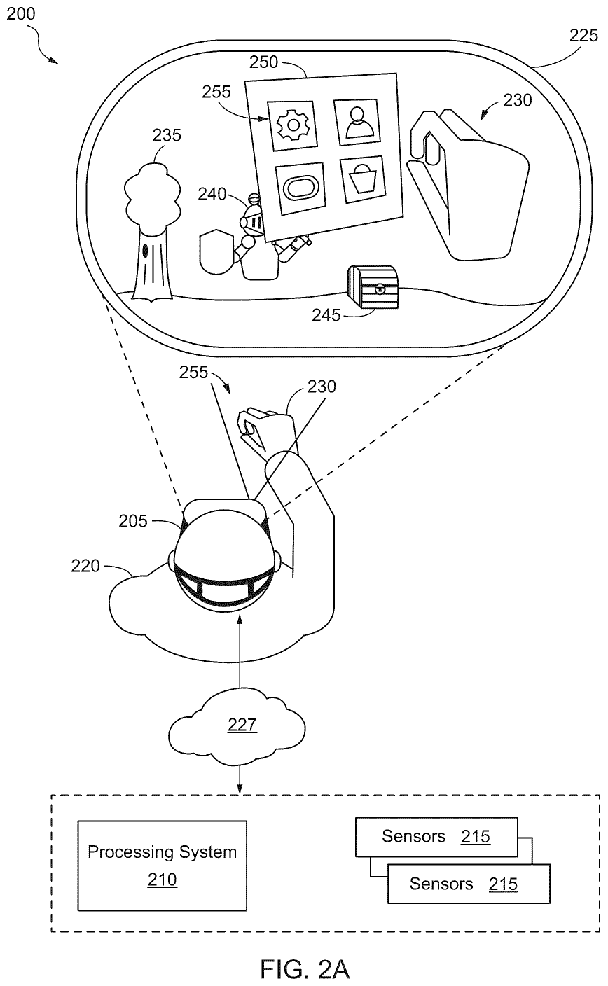

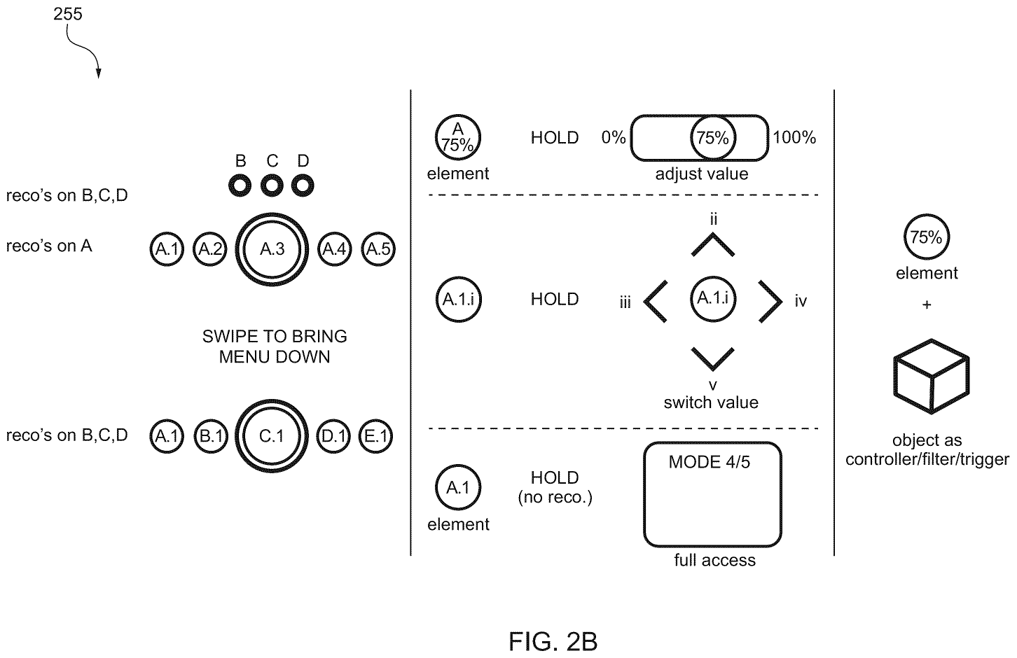

In various embodiments, a client system 105 is an electronic device including hardware, software, or embedded logic components or a combination of two or more such components and capable of carrying out the appropriate extended reality functionalities in accordance with techniques of the disclosure. As an example, and not by way of limitation, a client system 105 may include a desktop computer, notebook or laptop computer, netbook, a tablet computer, e-book reader, GPS device, camera, personal digital assistant (PDA), handheld electronic device, cellular telephone, smartphone, a VR. MR, AR, or VR headset such as an AR/VR HMD, other suitable electronic device capable of displaying extended reality content, or any suitable combination thereof. In particular embodiments, the client system 105 is an AR/VR HMD as described in detail with respect to FIG. 2. This disclosure contemplates any suitable client system 105 configured to generate and output extended reality content to the user. The client system 105 may enable its user to communicate with other users at other client systems 105.

In various embodiments, the client system 105 includes a virtual assistant application 130. The virtual assistant application 130 instantiates at least a portion of the virtual assistant, which can provide information or services to a user based on user input, contextual awareness (such as clues from the physical environment or clues from user behavior), and the capability to access information from a variety of online sources (such as weather conditions, traffic information, news, stock prices, user schedules, retail prices, etc.). As used herein, when an action is “based on” something, this means the action is based at least in part on at least a part of the something. The user input may include text (e.g., online chat), especially in an instant messaging application or other applications, voice, eye-tracking, user motion such as gestures or running, or a combination of them. The virtual assistant may perform concierge-type services (e.g., making dinner reservations, purchasing event tickets, making travel arrangements, and the like), provide information (e.g., reminders, information concerning an object in an environment, information concerning a task or interaction, answers to questions, training regarding a task or activity, and the like), goal assisted services (e.g., generating and implementing a recipe to cook a meal in a certain amount of time, implementing tasks to clean in a most efficient manner, generate and execute a construction plan including allocation of tasks to two or more workers, and the like), or combinations thereof. The virtual assistant may also perform management or data-handling tasks based on online information and events without user initiation or interaction. Examples of those tasks that may be performed by a virtual assistant may include schedule management (e.g., sending an alert to a dinner date that a user is running late due to traffic conditions, update schedules for both parties, and change the restaurant reservation time). The virtual assistant may be enabled in an extended reality environment by a combination of the client system 105, the virtual assistant engine 110, application programming interfaces (APIs), and the proliferation of applications on user devices such as the remote systems 115.

A user at the client system 105 may use the virtual assistant application 130 to interact with the virtual assistant engine 110. In some instances, the virtual assistant application 130 is a stand-alone application or integrated into another application such as a social-networking application or another suitable application (e.g., an artificial simulation application). In some instances, the virtual assistant application 130 is integrated into the client system 105 (e.g., part of the operating system of the client system 105), an assistant hardware device, or any other suitable hardware devices. In some instances, the virtual assistant application 130 may be accessed via a web browser 135. In some instances, the virtual assistant application 130 passively listens to and watches interactions of the user in the real-world, and processes what it hears and sees (e.g., explicit input such as audio commands or interface commands, contextual awareness derived from audio or physical actions of the user, objects in the real-world, environmental triggers such as weather or time, and the like) in order to interact with the user in an intuitive manner.

In particular embodiments, the virtual assistant application 130 receives or obtains input from a user, the physical environment, a virtual reality environment, or a combination thereof via different modalities. As an example, and not by way of limitation, the modalities may include audio, text, image, video, motion, graphical or virtual user interfaces, orientation, sensors, etc. The virtual assistant application 130 communicates the input to the virtual assistant engine 110. Based on the input, the virtual assistant engine 110 analyzes the input and generates responses (e.g., text or audio responses, device commands such as a signal to turn on a television, virtual content such as a virtual object, or the like) as output. The virtual assistant engine 110 may send the generated responses to the virtual assistant application 130, the client system 105, the remote systems 115, or a combination thereof. The virtual assistant application 130 may present the response to the user at the client system 130 (e.g., rendering virtual content overlaid on a real-world object within the display). The presented responses may be based on different modalities such as audio, text, image, and video. As an example, and not by way of limitation, context concerning activity of a user in the physical world may be analyzed and determined to initiate an interaction for completing an immediate task or goal, which may include the virtual assistant application 130 retrieving traffic information (e.g., via a remote system 115). The virtual assistant application 130 may communicate the request for traffic information to virtual assistant engine 110. The virtual assistant engine 110 may accordingly contact the remote system 115 and retrieve traffic information as a result of the request and send the traffic information back to the virtual assistant application 110. The virtual assistant application 110 may then present the traffic information to the user as text (e.g., as virtual content overlaid on the physical environment such as real-world object) or audio (e.g., spoken to the user in natural language through a speaker associated with the client system 105).

In various embodiments, the virtual assistant engine 110 assists users to retrieve information from different sources, request services from different service providers, assist users to learn or complete goals and tasks using different sources and/or service providers, and combinations thereof. In some instances, the virtual assistant engine 110 receives input data from the virtual assistant application 130 and determines one or more interactions based on the input data that could be executed to request information, services, and/or complete a goal or task of the user. The interactions are actions that could be presented to a user for execution in an extended reality environment. In some instances, the interactions are influenced by other actions associated with the user. The interactions are aligned with goals or tasks associated with the user. The goals may comprise, for example, things that a user wants to occur such as a meal, a piece of furniture, a repaired automobile, a house, a garden, a clean apartment, and the like. The tasks may comprise, for example, cooking a meal using one or more recipes, building a piece of furniture, repairing a vehicle, building a house, planting a garden, cleaning one or more rooms of an apartment, and the like. Each goal and task may be associated with a workflow of actions or sub-tasks for performing the task and achieving the goal. For example, for preparing a salad, the a workflow of actions or sub-tasks may comprise ingredients needed, any equipment need for the steps (e.g., a knife, a stove top, a pan, a salad spinner, etc.), sub-tasks for preparing ingredients (e.g., chopping onions, cleaning lettuce, cooking chicken, etc.), and sub-tasks for combining ingredients into subcomponents (e.g., cooking chicken with olive oil and Italian seasonings).

The virtual assistant engine 110 may use artificial intelligence systems 140 (e.g., rule-based systems or machine-learning based systems such as natural-language understanding models) to analyze the input based on a user's profile and other relevant information. The result of the analysis may comprise different interactions associated with a task or goal of the user. The virtual assistant 110 may then retrieve information, request services, and/or generate instructions, recommendations, or virtual content associated with one or more of the different interactions for completing tasks or goals. In some instances, the virtual assistant engine 110 interacts with a remote system 115 such as a social-networking system 145 when retrieving information, requesting service, and/or generate instructions or recommendations for the user. The virtual assistant engine 110 may generate virtual content for the user using various techniques such as natural language generating, virtual object rendering, and the like. The virtual content may comprise, for example, the retrieved information, the status of the requested services, a virtual object such as a glimmer overlaid on a physical object such as a appliance, light, or piece of exercise equipment, a demonstration for a task, and the like. In particular embodiments, the virtual assistant engine 110 enables the user to interact with it regarding the information, services, or goals using a graphical or virtual interface, a stateful and multi-turn conversation using dialog-management techniques, and/or a stateful and multi-action interaction using task-management techniques.

In various embodiments, a remote system 115 may include one or more types of servers, one or more data stores, one or more interfaces, including but not limited to APIs, one or more web services, one or more content sources, one or more networks, or any other suitable components, e.g., that servers may communicate with. A remote system 115 may be operated by a same entity or a different entity from an entity operating the virtual assistant engine 110. In particular embodiments, however, the virtual assistant engine 110 and third-party systems 115 may operate in conjunction with each other to provide virtual content to users of the client system 105. For example, a social-networking system 145 may provide a platform, or backbone, which other systems, such as third-party systems, may use to provide social-networking services and functionality to users across the Internet, and the virtual assistant engine 110 may access these systems to provide virtual content on the client system 105.

In particular embodiments, the social-networking system 145 may be a network-addressable computing system that can host an online social network. The social-networking system 145 may generate, store, receive, and send social-networking data, such as, for example, user-profile data, concept-profile data, social-graph information, or other suitable data related to the online social network. The social-networking system 145 may be accessed by the other components of network environment 100 either directly or via a network 120. As an example, and not by way of limitation, a client system 105 may access the social-networking system 145 using a web browser 135, or a native application associated with the social-networking system 145 (e.g., a mobile social-networking application, a messaging application, another suitable application, or any combination thereof) either directly or via a network 120. The social-networking system 145 may provide users with the ability to take actions on various types of items or objects, supported by the social-networking system 145. As an example and not by way of limitation, the items and objects may include groups or social networks to which users of the social-networking system 145 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 145 or by an external system of the remote systems 115, which is separate from the social-networking system 145 and coupled to the social-networking system 115 via the network 120.

The remote system 115 may include a content object provider 150. A content object provider 150 includes one or more sources of virtual content objects, which may be communicated to the client system 105. As an example, and not by way of limitation, virtual content objects may include information regarding things or activities of interest to the user, such as, for example, movie show times, movie reviews, restaurant reviews, restaurant menus, product information and reviews, instructions on how to perform various tasks, exercise regimens, cooking recipes, or other suitable information. As another example and not by way of limitation, content objects may include incentive content objects, such as coupons, discount tickets, gift certificates, or other suitable incentive objects. As another example and not by way of limitation, content objects may include virtual objects such as virtual interfaces, 2D or 3D graphics, media content, or other suitable virtual objects.

FIG. 2A illustrates an example client system 200 (e.g., client system 105 described with respect to FIG. 1) in accordance with aspects of the present disclosure. Client system 200 includes an extended reality system 205 (e.g., a HMD), a processing system 210, and one or more sensors 215. As shown, extended reality system 205 is typically worn by user 220 and comprises an electronic display (e.g., a transparent, translucent, or solid display), optional controllers, and optical assembly for presenting extended reality content 225 to the user 220. The one or more sensors 215 may include motion sensors (e.g., accelerometers) for tracking motion of the extended reality system 205 and may include one or more image capture devices (e.g., cameras, line scanners) for capturing image data of the surrounding physical environment. In this example, processing system 210 is shown as a single computing device, such as a gaming console, workstation, a desktop computer, or a laptop. In other examples, processing system 210 may be distributed across a plurality of computing devices, such as a distributed computing network, a data center, or a cloud computing system. In other examples, processing system 210 may be integrated with the extended reality system 205. The extended reality system 205, the processing system 210, and the one or more sensors 215 are communicatively coupled via a network 227, which may be a wired or wireless network, such as Wi-Fi, a mesh network or a short-range wireless communication medium such as Bluetooth wireless technology, or a combination thereof. Although extended reality system 205 is shown in this example as in communication with, e.g., tethered to or in wireless communication with, processing system 210, in some implementations extended reality system 205 operates as a stand-alone, mobile extended reality system.

In general, client system 200 uses information captured from a real-world, physical environment to render extended reality content 225 for display to the user 220. In the example of FIG. 2, the user 220 views the extended reality content 225 constructed and rendered by an extended reality application executing on processing system 210 and/or extended reality system 205. In some examples, the extended reality content 225 viewed through the extended reality system 205 comprises a mixture of real-world imagery (e.g., the user's hand 230 and physical objects 235) and virtual imagery (e.g., virtual content such as information or objects 240, 245 and virtual user interface 250) to produce mixed reality and/or augmented reality. In some examples, virtual information or objects 240, 245 may be mapped (e.g., pinned, locked, placed) to a particular position within extended reality content 225. For example, a position for virtual information or objects 240, 245 may be fixed, as relative to one of walls of a residence or surface of the earth, for instance. A position for virtual information or objects 240, 245 may be variable, as relative to a physical object 235 or the user 220, for instance. In some examples, the particular position of virtual information or objects 240, 245 within the extended reality content 225 is associated with a position within the real world, physical environment (e.g., on a surface of a physical object 235).

In the example shown in FIG. 2A, virtual information or objects 240, 245 are mapped at a position relative to a physical object 235. As should be understood, the virtual imagery (e.g., virtual content such as information or objects 240, 245 and virtual user interface 250) does not exist in the real-world, physical environment. Virtual user interface 250 may be fixed, as relative to the user 220, the user's hand 230, physical objects 235, or other virtual content such as virtual information or objects 240, 245, for instance. As a result, client system 200 renders, at a user interface position that is locked relative to a position of the user 220, the user's hand 230, physical objects 235, or other virtual content in the extended reality environment, virtual user interface 250 for display at extended reality system 205 as part of extended reality content 225. As used herein, a virtual element ‘locked’ to a position of virtual content or physical object is rendered at a position relative to the position of the virtual content or physical object so as to appear to be part of or otherwise tied in the extended reality environment to the virtual content or physical object.

In some implementations, the client system 200 generates and renders virtual content (e.g., GIFs, photos, applications, live-streams, videos, text, a web-browser, drawings, animations, representations of data files, or any other visible media) on a virtual surface. A virtual surface may be associated with a planar or other real-world surface (e.g., the virtual surface corresponds to and is locked to a physical surface, such as a wall table, or ceiling). In the example shown in FIG. 2A, the virtual surface is associated with the sky and ground of the physical environment. In other examples, a virtual surface can be associated with a portion of a surface (e.g., a portion of the wall). In some examples, only the virtual content items contained within a virtual surface are rendered. In other examples, the virtual surface is generated and rendered (e.g., as a virtual plane or as a border corresponding to the virtual surface). In some examples, a virtual surface can be rendered as floating in a virtual or real-world physical environment (e.g., not associated with a particular real-world surface). The client system 200 may render one or more virtual content items in response to a determination that at least a portion of the location of virtual content items is in a field of view of the user 220. For example, client system 200 may render virtual user interface 250 only if a given physical object (e.g., a lamp) is within the field of view of the user 220.

During operation, the extended reality application constructs extended reality content 225 for display to user 220 by tracking and computing interaction information (e.g., tasks for completion) for a frame of reference, typically a viewing perspective of extended reality system 205. Using extended reality system 205 as a frame of reference and based on a current field of view as determined by a current estimated interaction of extended reality system 205, the extended reality application renders extended reality content 225 which, in some examples, may be overlaid, at least in part, upon the real-world, physical environment of the user 220. During this process, the extended reality application uses sensed data received from extended reality system 205 and sensors 215, such as movement information, contextual awareness, and/or user commands, and, in some examples, data from any external sensors, such as third-party information or device, to capture information within the real world, physical environment, such as motion by user 220 and/or feature tracking information with respect to user 220. Based on the sensed data, the extended reality application determines interaction information to be presented for the frame of reference of extended reality system 205 and, in accordance with the current context of the user 220, renders the extended reality content 225.

Client system 200 may trigger generation and rendering of virtual content based on a current field of view of user 220, as may be determined by real-time gaze 255 tracking of the user, or other conditions. More specifically, image capture devices of the sensors 215 capture image data representative of objects in the real world, physical environment that are within a field of view of image capture devices. During operation, the client system 200 performs object recognition within image data captured by the image capture devices of extended reality system 205 to identify objects in the physical environment such as the user 220, the user's hand 230, and/or physical objects 235. Further, the client system 200 tracks the position, orientation, and configuration of the objects in the physical environment over a sliding window of time. Field of view typically corresponds with the viewing perspective of the extended reality system 205. In some examples, the extended reality application presents extended reality content 225 comprising mixed reality and/or augmented reality.

As illustrated in FIG. 2A, the extended reality application may render virtual content, such as virtual information or objects 240, 245 on a transparent display such that the virtual content is overlaid on real-world objects, such as the portions of the user 220, the user's hand 230, physical objects 235, that are within a field of view of the user 220. In other examples, the extended reality application may render images of real-world objects, such as the portions of the user 220, the user's hand 230, physical objects 235, that are within field of view along with virtual objects, such as virtual information or objects 240, 245 within extended reality content 225. In other examples, the extended reality application may render virtual representations of the portions of the user 220, the user's hand 230, physical objects 235 that are within field of view (e.g., render real-world objects as virtual objects) within extended reality content 225. In either example, user 220 is able to view the portions of the user 220, the user's hand 230, physical objects 235 and/or any other real-world objects or virtual content that are within field of view within extended reality content 225. In other examples, the extended reality application may not render representations of the user 220 and the user's hand 230; and instead, only render the physical objects 235 and/or virtual information or objects 240, 245.

In various embodiments, the client system 200 renders to extended reality system 205 extended reality content 225 in which virtual user interface 250 is locked relative to a position of the user 220, the user's hand 230, physical objects 235, or other virtual content in the extended reality environment. That is, the client system 200 may render a virtual user interface 250 having one or more virtual user interface elements at a position and orientation that is based on and corresponds to the position and orientation of the user 220, the user's hand 230, physical objects 235, or other virtual content in the extended reality environment. For example, if a physical object is positioned in a vertical position on a table, the client system 200 may render the virtual user interface 250 at a location corresponding to the position and orientation of the physical object in the extended reality environment. Alternatively, if the user's hand 230 is within the field of view, the client system 200 may render the virtual user interface at a location corresponding to the position and orientation of the user's hand 230 in the extended reality environment. Alternatively, if other virtual content is within the field of view, the client system 200 may render the virtual user interface at a location corresponding to a general predetermined position of the field of view (e.g., a bottom of the field of view) in the extended reality environment. Alternatively, if other virtual content is within the field of view, the client system 200 may render the virtual user interface at a location corresponding to the position and orientation of the other virtual content in the extended reality environment. In this way, the virtual user interface 250 being rendered in the virtual environment may track the user 220, the user's hand 230, physical objects 235, or other virtual content such that the user interface appears, to the user, to be associated with the user 220, the user's hand 230, physical objects 235, or other virtual content in the extended reality environment.

The virtual user interface 250 may include one or more virtual user interface elements 255. As shown in FIG. 2B, the virtual user interface elements 255 may include, for instance, a virtual drawing interface, a selectable menu (e.g., a drop-down menu), virtual buttons, a virtual slider or scroll bar, a directional pad, a keyboard, or other user-selectable user interface elements, glyphs, display elements, content, user interface controls, and so forth. The particular virtual user interface elements 255 for virtual user interface 250 may be context-driven based on the current extended reality applications engaged by the user 220 or real-world actions/tasks being performed by the user 220. When a user performs a user interface gesture in the extended reality environment at a location that corresponds to one of the virtual user interface elements 255 of virtual user interface 250, the client system 200 detects the gesture relative to the virtual user interface elements 255 and performs an action associated with the gesture and the virtual user interface elements 255. For example, the user 220 may press their finger at a button element 255 location on the virtual user interface 250. The button element 255 and/or virtual user interface 250 location may or may not be overlaid on the user 220, the user's hand 230, physical objects 235, or other virtual content, e.g., correspond to a position in the physical environment such as on a light switch or controller at which the client system 200 renders the virtual user interface button. In this example, the client system 200 detects this virtual button press gesture and performs an action corresponding to the detected press of a virtual user interface button (e.g., turns the light on). The client system 200 may also, for instance, animate a press of the virtual user interface button along with the button press gesture.

The client system 200 may detect user interface gestures and other gestures using an inside-out or outside-in tracking system of image capture devices and or external cameras. The client system 200 may alternatively, or in addition, detect user interface gestures and other gestures using a presence-sensitive surface. That is, a presence-sensitive interface of the extended reality system 205 and/or controller may receive user inputs that make up a user interface gesture. The extended reality system 205 and/or controller may provide haptic feedback to touch-based user interaction by having a physical surface with which the user can interact (e.g., touch, drag a finger across, grab, and so forth). In addition, peripheral extended reality system 205 and/or controller may output other indications of user interaction using an output device. For example, in response to a detected press of a virtual user interface button, extended reality system 205 and/or controller may output a vibration or “click” noise, or extended reality system 205 and/or controller may generate and output content to a display. In some examples, the user 220 may press and drag their finger along physical locations on the extended reality system 205 and/or controller corresponding to positions in the virtual environment at which the client system 200 renders virtual user interface elements 255 of virtual user interface 250. In this example, the client system 200 detects this gesture and performs an action according to the detected press and drag of virtual user interface elements 255, such as by moving a slider bar in the virtual environment. In this way, client system 200 simulates movement of virtual content using virtual user interface elements 255 and gestures.

Various embodiments disclosed herein may include or be implemented in conjunction with various types of extended reality systems. Extended reality content generated by the extended reality systems may include completely computer-generated content or computer-generated content combined with captured (e.g., real-world) content. The extended reality content may include video, audio, haptic feedback, or some combination thereof, any of which may be presented in a single channel or in multiple channels (such as stereo video that produces a three-dimensional (3D) effect to the viewer). Additionally, in some embodiments, extended reality may also be associated with applications, products, accessories, services, or some combination thereof, that are used to, for example, create content in an extended reality and/or are otherwise used in (e.g., to perform activities in) an extended reality.

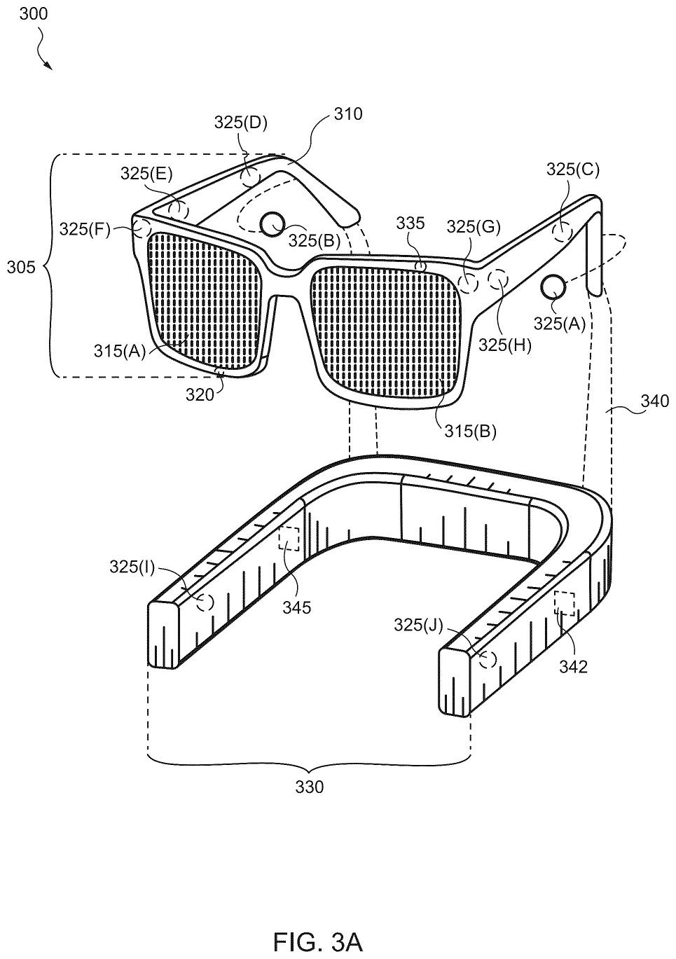

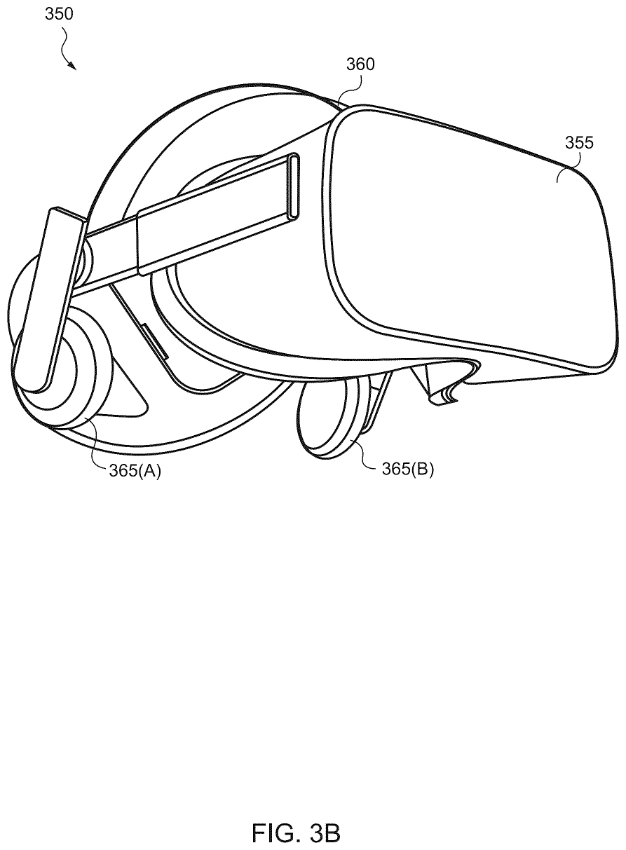

The extended reality systems may be implemented in a variety of different form factors and configurations. Some extended reality systems may be designed to work without near-eye displays (NEDs). Other extended reality systems may include an NED that also provides visibility into the real world (such as, e.g., augmented reality system 300 in FIG. 3A) or that visually immerses a user in an extended reality (such as, e.g., virtual reality system 350 in FIG. 3B). While some extended reality devices may be self-contained systems, other extended reality devices may communicate and/or coordinate with external devices to provide an extended reality experience to a user. Examples of such external devices include handheld controllers, mobile devices, desktop computers, devices worn by a user, devices worn by one or more other users, and/or any other suitable external system.

As shown in FIG. 3A, augmented reality system 300 may include an eyewear device 305 with a frame 310 configured to hold a left display device 315(A) and a right display device 315(B) in front of a user's eyes. Display devices 315(A) and 315(B) may act together or independently to present an image or series of images to a user. While augmented reality system 300 includes two displays, embodiments of this disclosure may be implemented in augmented reality systems with a single NED or more than two NEDs.

In some embodiments, augmented reality system 300 may include one or more sensors, such as sensor 320. Sensor 320 may generate measurement signals in response to motion of augmented reality system 300 and may be located on substantially any portion of frame 310. Sensor 320 may represent one or more of a variety of different sensing mechanisms, such as a position sensor, an inertial measurement unit (IMU), a depth camera assembly, a structured light emitter and/or detector, or any combination thereof. In some embodiments, augmented reality system 300 may or may not include sensor 320 or may include more than one sensor. In embodiments in which sensor 320 includes an IMU, the IMU may generate calibration data based on measurement signals from sensor 320. Examples of sensor 320 may include, without limitation, accelerometers, gyroscopes, magnetometers, other suitable types of sensors that detect motion, sensors used for error correction of the IMU, or some combination thereof.

In some examples, augmented reality system 300 may also include a microphone array with a plurality of acoustic transducers 325(A)-325(J), referred to collectively as acoustic transducers 325. Acoustic transducers 325 may represent transducers that detect air pressure variations induced by sound waves. Each acoustic transducer 325 may be configured to detect sound and convert the detected sound into an electronic format (e.g., an analog or digital format). The microphone array in FIG. 3A may include, for example, ten acoustic transducers: 325(A) and 325(B), which may be designed to be placed inside a corresponding ear of the user, acoustic transducers 325(C), 325(D), 325(E), 325(F), 325(G), and 325(H), which may be positioned at various locations on frame 310, and/or acoustic transducers 325(I) and 325(J), which may be positioned on a corresponding neckband 330.

In some embodiments, one or more of acoustic transducers 325(A)-(J) may be used as output transducers (e.g., speakers). For example, acoustic transducers 325(A) and/or 325(B) may be earbuds or any other suitable type of headphone or speaker. The configuration of acoustic transducers 325 of the microphone array may vary. While augmented reality system 300 is shown in FIG. 3 as having ten acoustic transducers 325, the number of acoustic transducers 325 may be greater or less than ten. In some embodiments, using higher numbers of acoustic transducers 325 may increase the amount of audio information collected and/or the sensitivity and accuracy of the audio information. In contrast, using a lower number of acoustic transducers 325 may decrease the computing power required by an associated controller 335 to process the collected audio information. In addition, the position of each acoustic transducer 325 of the microphone array may vary. For example, the position of an acoustic transducer 325 may include a defined position on the user, a defined coordinate on frame 310, an orientation associated with each acoustic transducer 325, or some combination thereof.

Acoustic transducers 325(A) and 325(B) may be positioned on different parts of the user's ear, such as behind the pinna, behind the tragus, and/or within the auricle or fossa. Or, there may be additional acoustic transducers 325 on or surrounding the ear in addition to acoustic transducers 325 inside the ear canal. Having an acoustic transducer 325 positioned next to an ear canal of a user may enable the microphone array to collect information on how sounds arrive at the ear canal. By positioning at least two of acoustic transducers 325 on either side of a user's head (e.g., as binaural microphones), augmented reality system 300 may simulate binaural hearing and capture a 3D stereo sound field around about a user's head. In some embodiments, acoustic transducers 325(A) and 325(B) may be connected to augmented reality system 300 via a wired connection 340, and in other embodiments acoustic transducers 325(A) and 325(B) may be connected to augmented reality system 300 via a wireless connection (e.g., a Bluetooth connection). In still other embodiments, acoustic transducers 325(A) and 325(B) may not be used at all in conjunction with augmented reality system 300.

Acoustic transducers 325 on frame 310 may be positioned in a variety of different ways, including along the length of the temples, across the bridge, above or below display devices 315(A) and 315(B), or some combination thereof. Acoustic transducers 325 may also be oriented such that the microphone array is able to detect sounds in a wide range of directions surrounding the user wearing the augmented reality system 300. In some embodiments, an optimization process may be performed during manufacturing of augmented reality system 300 to determine relative positioning of each acoustic transducer 325 in the microphone array.

In some examples, augmented reality system 300 may include or be connected to an external device (e.g., a paired device), such as neckband 330. Neckband 330 generally represents any type or form of paired device. Thus, the following discussion of neckband 330 may also apply to various other paired devices, such as charging cases, smart watches, smart phones, wrist bands, other wearable devices, hand-held controllers, tablet computers, laptop computers, other external compute devices, etc.

As shown, neckband 330 may be coupled to eyewear device 305 via one or more connectors. The connectors may be wired or wireless and may include electrical and/or non-electrical (e.g., structural) components. In some cases, eyewear device 305 and neckband 330 may operate independently without any wired or wireless connection between them. While FIG. 3A illustrates the components of eyewear device 305 and neckband 330 in example locations on eyewear device 305 and neckband 330, the components may be located elsewhere and/or distributed differently on eyewear device 305 and/or neckband 330. In some embodiments, the components of eyewear device 305 and neckband 330 may be located on one or more additional peripheral devices paired with eyewear device 305, neckband 330, or some combination thereof.

Pairing external devices, such as neckband 330, with augmented reality eyewear devices may enable the eyewear devices to achieve the form factor of a pair of glasses while still providing sufficient battery and computation power for expanded capabilities. Some or all of the battery power, computational resources, and/or additional features of augmented reality system 300 may be provided by a paired device or shared between a paired device and an eyewear device, thus reducing the weight, heat profile, and form factor of the eyewear device overall while still retaining desired functionality. For example, neckband 330 may allow components that would otherwise be included on an eyewear device to be included in neckband 330 since users may tolerate a heavier weight load on their shoulders than they would tolerate on their heads. Neckband 330 may also have a larger surface area over which to diffuse and disperse heat to the ambient environment. Thus, neckband 330 may allow for greater battery and computation capacity than might otherwise have been possible on a stand-alone eyewear device. Since weight carried in neckband 330 may be less invasive to a user than weight carried in eyewear device 305, a user may tolerate wearing a lighter eyewear device and carrying or wearing the paired device for greater lengths of time than a user would tolerate wearing a heavy standalone eyewear device, thereby enabling users to more fully incorporate extended reality environments into their day-to-day activities.

Neckband 330 may be communicatively coupled with eyewear device 305 and/or to other devices. These other devices may provide certain functions (e.g., tracking, localizing, depth mapping, processing, storage, etc.) to augmented reality system 300. In the embodiment of FIG. 3A, neckband 330 may include two acoustic transducers (e.g., 325(I) and 325(J)) that are part of the microphone array (or potentially form their own microphone subarray). Neckband 330 may also include a controller 342 and a power source 345.

Acoustic transducers 325(I) and 325(J) of neckband 330 may be configured to detect sound and convert the detected sound into an electronic format (analog or digital). In the embodiment of FIG. 3A, acoustic transducers 325(I) and 325(J) may be positioned on neckband 330, thereby increasing the distance between the neckband acoustic transducers 325(I) and 325(J) and other acoustic transducers 325 positioned on eyewear device 305. In some cases, increasing the distance between acoustic transducers 325 of the microphone array may improve the accuracy of beamforming performed via the microphone array. For example, if a sound is detected by acoustic transducers 325(C) and 325(D) and the distance between acoustic transducers 325(C) and 325(D) is greater than, e.g., the distance between acoustic transducers 325(D) and 325(E), the determined source location of the detected sound may be more accurate than if the sound had been detected by acoustic transducers 325(D) and 325(E).

Controller 342 of neckband 330 may process information generated by the sensors on neckband 330 and/or augmented reality system 300. For example, controller 342 may process information from the microphone array that describes sounds detected by the microphone array. For each detected sound, controller 342 may perform a direction-of-arrival (DOA) estimation to estimate a direction from which the detected sound arrived at the microphone array. As the microphone array detects sounds, controller 342 may populate an audio data set with the information. In embodiments in which augmented reality system 300 includes an inertial measurement unit, controller 342 may compute all inertial and spatial calculations from the IMU located on eyewear device 305. A connector may convey information between augmented reality system 300 and neckband 330 and between augmented reality system 300 and controller 342. The information may be in the form of optical data, electrical data, wireless data, or any other transmittable data form. Moving the processing of information generated by augmented reality system 300 to neckband 330 may reduce weight and heat in eyewear device 305, making it more comfortable to the user.

Power source 345 in neckband 330 may provide power to eyewear device 305 and/or to neckband 330. Power source 345 may include, without limitation, lithium-ion batteries, lithium-polymer batteries, primary lithium batteries, alkaline batteries, or any other form of power storage. In some cases, power source 345 may be a wired power source. Including power source 345 on neckband 330 instead of on eyewear device 305 may help better distribute the weight and heat generated by power source 345.

As noted, some extended reality systems may, instead of blending an extended reality with actual reality, substantially replace one or more of a user's sensory perceptions of the real world with a virtual experience. One example of this type of system is a head-worn display system, such as virtual reality system 350 in FIG. 3B, that mostly or completely covers a user's field of view. Virtual reality system 350 may include a front rigid body 355 and a band 360 shaped to fit around a user's head. Virtual reality system 1700 may also include output audio transducers 365(A) and 365(B). Furthermore, while not shown in FIG. 3B, front rigid body 355 may include one or more electronic elements, including one or more electronic displays, one or more inertial measurement units (IMUs), one or more tracking emitters or detectors, and/or any other suitable device or system for creating an extended reality experience.

Extended reality systems may include a variety of types of visual feedback mechanisms. For example, display devices in augmented reality system 300 and/or virtual reality system 350 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These extended reality systems may include a single display screen for both eyes or may provide a display screen for each eye, which may allow for additional flexibility for varifocal adjustments or for correcting a user's refractive error. Some of these extended reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the extended reality systems described herein may include one or more projection systems. For example, display devices in augmented reality system 300 and/or virtual reality system 350 may include micro-LED projectors that project light (using, e.g., a waveguide) into display devices, such as clear combiner lenses that allow ambient light to pass through. The display devices may refract the projected light toward a user's pupil and may enable a user to simultaneously view both extended reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Extended reality systems may also be configured with any other suitable type or form of image projection system, such as retinal projectors used in virtual retina displays.

The extended reality systems described herein may also include various types of computer vision components and subsystems. For example, augmented reality system 300 and/or virtual reality system 350 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An extended reality system may process data from one or more of these sensors to identify a location of a user, to map the real world, to provide a user with context about real-world surroundings, and/or to perform a variety of other functions.

The extended reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the extended reality systems described herein may also include tactile (e.g., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other extended reality devices, within other extended reality devices, and/or in conjunction with other extended reality devices.

By providing haptic sensations, audible content, and/or visual content, extended reality systems may create an entire virtual experience or enhance a user's real-world experience in a variety of contexts and environments. For instance, extended reality systems may assist or extend a user's perception, memory, or cognition within a particular environment. Some systems may enhance a user's interactions with other people in the real world or may enable more immersive interactions with other people in a virtual world. Extended reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's extended reality experience in one or more of these contexts and environments and/or in other contexts and environments.

As noted, extended reality systems 300 and 350 may be used with a variety of other types of devices to provide a more compelling extended reality experience. These devices may be haptic interfaces with transducers that provide haptic feedback and/or that collect haptic information about a user's interaction with an environment. The extended reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

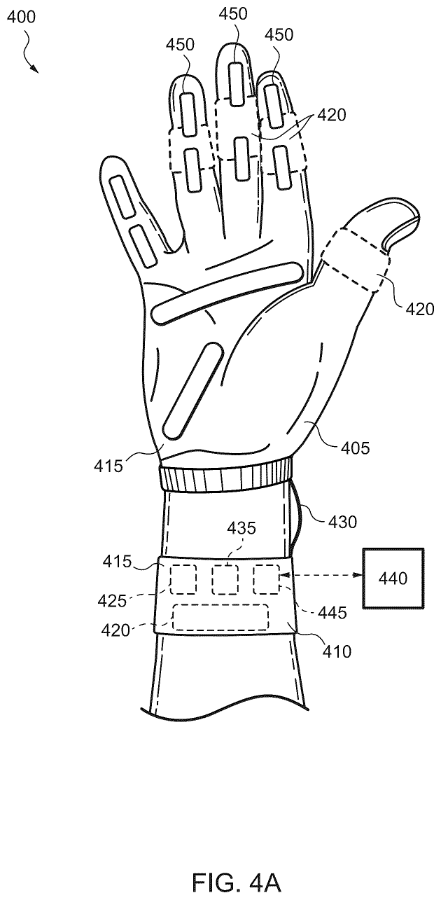

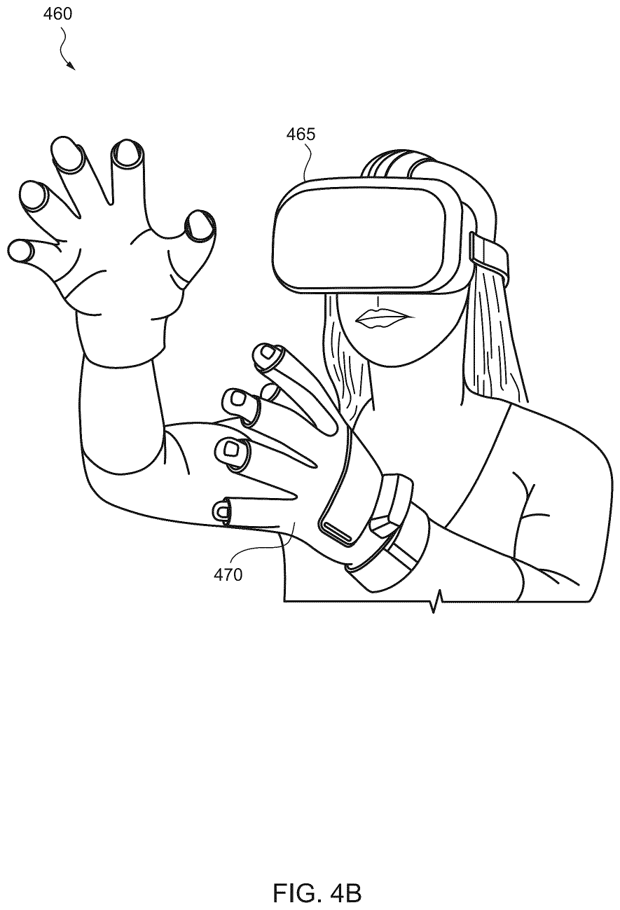

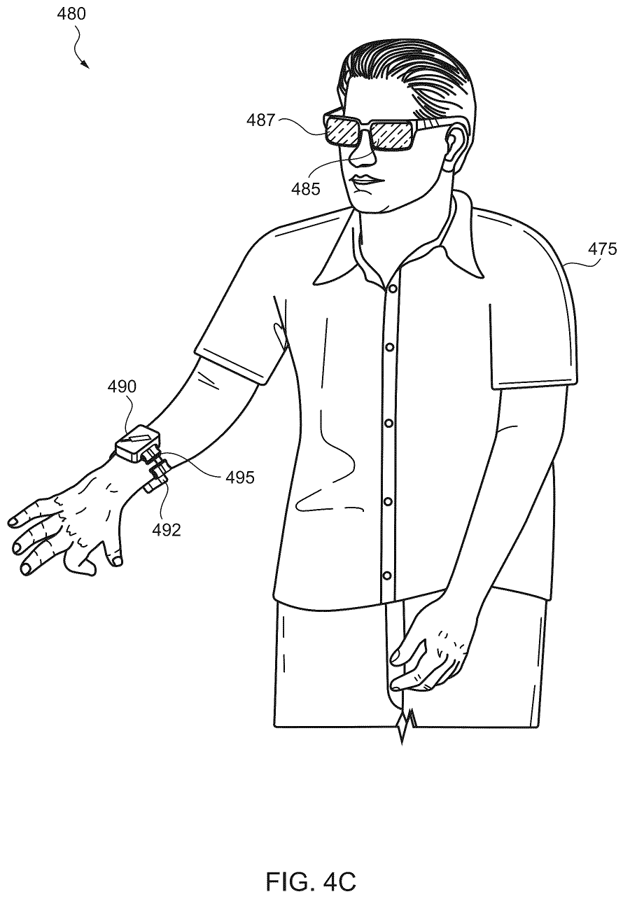

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 4A illustrates a vibrotactile system 400 in the form of a wearable glove (haptic device 405) and wristband (haptic device 410). Haptic device 405 and haptic device 410 are shown as examples of wearable devices that include a flexible, wearable textile material 415 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 420 may be positioned at least partially within one or more corresponding pockets formed in textile material 415 of vibrotactile system 400. Vibrotactile devices 420 may be positioned in locations to provide a vibrating sensation (e.g., haptic feedback) to a user of vibrotactile system 400. For example, vibrotactile devices 420 may be positioned against the user's finger(s), thumb, or wrist, as shown in FIG. 4A. Vibrotactile devices 420 may, in some examples, be sufficiently flexible to conform to or bend with the user's corresponding body part(s).

A power source 425 (e.g., a battery) for applying a voltage to the vibrotactile devices 420 for activation thereof may be electrically coupled to vibrotactile devices 420, such as via conductive wiring 430. In some examples, each of vibrotactile devices 420 may be independently electrically coupled to power source 425 for individual activation. In some embodiments, a processor 435 may be operatively coupled to power source 425 and configured (e.g., programmed) to control activation of vibrotactile devices 420.

Vibrotactile system 400 may be implemented in a variety of ways. In some examples, vibrotactile system 400 may be a standalone system with integral subsystems and components for operation independent of other devices and systems. As another example, vibrotactile system 400 may be configured for interaction with another device or system 440. For example, vibrotactile system 400 may, in some examples, include a communications interface 445 for receiving and/or sending signals to the other device or system 440. The other device or system 440 may be a mobile device, a gaming console, an extended reality (e.g., virtual reality, augmented reality, mixed-reality) device, a personal computer, a tablet computer, a network device (e.g., a modem, a router, etc.), a handheld controller, etc. Communications interface 445 may enable communications between vibrotactile system 400 and the other device or system 440 via a wireless (e.g., Wi-Fi, Bluetooth, cellular, radio, etc.) link or a wired link. If present, communications interface 445 may be in communication with processor 435, such as to provide a signal to processor 435 to activate or deactivate one or more of the vibrotactile devices 420.

Vibrotactile system 400 may optionally include other subsystems and components, such as touch-sensitive pads 450, pressure sensors, motion sensors, position sensors, lighting elements, and/or user interface elements (e.g., an on/off button, a vibration control element, etc.). During use, vibrotactile devices 420 may be configured to be activated for a variety of different reasons, such as in response to the user's interaction with user interface elements, a signal from the motion or position sensors, a signal from the touch-sensitive pads 450, a signal from the pressure sensors, a signal from the other device or system 440, etc.

Although power source 425, processor 435, and communications interface 445 are illustrated in FIG. 4A as being positioned in haptic device 410, the present disclosure is not so limited. For example, one or more of power source 425, processor 435, or communications interface 445 may be positioned within haptic device 405 or within another wearable textile.

Haptic wearables, such as those shown in and described in connection with FIG. 4A, may be implemented in a variety of types of extended reality systems and environments. FIG. 4B shows an example extended reality environment 460 including one head-mounted virtual reality display and two haptic devices (e.g., gloves), and in other embodiments any number and/or combination of these components and other components may be included in an extended reality system. For example, in some embodiments there may be multiple head-mounted displays each having an associated haptic device, with each head-mounted display and each haptic device communicating with the same console, portable computing device, or other computing system.

HMD 465 generally represents any type or form of virtual reality system, such as virtual reality system 350 in FIG. 3B. Haptic device 470 generally represents any type or form of wearable device, worn by a user of an extended reality system, that provides haptic feedback to the user to give the user the perception that he or she is physically engaging with a virtual object. In some embodiments, haptic device 470 may provide haptic feedback by applying vibration, motion, and/or force to the user. For example, haptic device 470 may limit or augment a user's movement. To give a specific example, haptic device 470 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 470 to send action requests to a console. Examples of action requests include, without limitation, requests to start an application and/or end the application and/or requests to perform a particular action within the application.

While haptic interfaces may be used with virtual reality systems, as shown in FIG. 4B, haptic interfaces may also be used with augmented reality systems, as shown in FIG. 4C. FIG. 4C is a perspective view of a user 475 interacting with an augmented reality system 480. In this example, user 475 may wear a pair of augmented reality glasses 485 that may have one or more displays 487 and that are paired with a haptic device 490. In this example, haptic device 490 may be a wristband that includes a plurality of band elements 492 and a tensioning mechanism 495 that connects band elements 492 to one another.

One or more of band elements 492 may include any type or form of actuator suitable for providing haptic feedback. For example, one or more of band elements 492 may be configured to provide one or more of various types of cutaneous feedback, including vibration, force, traction, texture, and/or temperature. To provide such feedback, band elements 492 may include one or more of various types of actuators. In one example, each of band elements 492 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 405, 410, 470, and 490 may include any suitable number and/or type of haptic transducer, sensor, and/or feedback mechanism. For example, haptic devices 405, 410, 470, and 490 may include one or more mechanical transducers, piezoelectric transducers, and/or fluidic transducers. Haptic devices 405, 410, 470, and 490 may also include various combinations of different types and forms of transducers that work together or independently to enhance a user's extended reality experience. In one example, each of band elements 492 of haptic device 490 may include a vibrotactor (e.g., a vibrotactile actuator) configured to vibrate in unison or independently to provide one or more of various types of haptic sensations to a user.

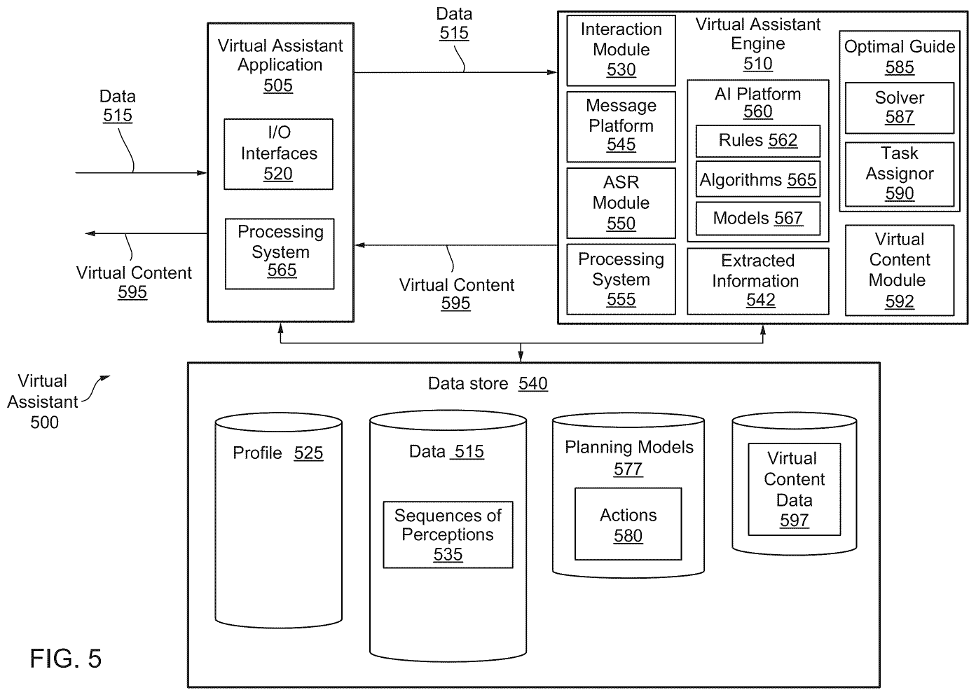

FIG. 5 illustrates an example architecture of a virtual assistant 500. In various embodiments, the virtual assistant 500 is an engineered entity residing in software, hardware, or a combination thereof that interfaces with users in a human way. The virtual assistant 500 incorporates elements of interactive responses (e.g., voice or text) and context awareness to assist, e.g., deliver information and services, users via one or more interactions. The virtual assistant 500 is instantiated using a virtual assistant application 505 (e.g., virtual assistant application 130 as described with respect to FIG. 1) on the client system and a virtual assistant engine 510 (e.g., virtual assistant engine 110 as described with respect to FIG. 1) on the client system, a separate computing system remote from the client system, or a combination thereof. The virtual assistant application 505 and the virtual assistant engine 510 assist users to retrieve information from different sources, request services from different service providers, assist users to learn or complete goals and tasks using different sources and/or service providers, and combinations thereof.

The data 515 is obtained from input associated with the user. More specifically, the virtual assistant application 505 obtains the data 515 in a passive or active manner as the user utilizes the client system, e.g., wears the HMD while performing an activity. The data 515 is obtained using one or more I/O interfaces 520, which allow for communicating with external devices, such as a keyboard, game controllers, display devices, image capture devices, HMDs, and the like. Moreover, the one or more I/O interfaces 520 may include one or more wired or wireless NICs for communicating with a network, such as network 120 described with respect to FIG. 1. A passive manner means that the virtual assistant application 505 obtains data via the image capture devices, sensors, remote systems, the like, or combinations thereof without prompting the user with virtual content, e.g., text, audio, glimmers, etc. An active manner means that the virtual assistant application 505 obtains data via the image capture devices, sensors, remote systems, the like, or combinations thereof by prompting the user with virtual content, e.g., text, audio, glimmers, etc. The data 515 includes: (i) data regarding activity of the user in a physical environment, a virtual environment, or a combination thereof (e.g., an extended reality environment comprising images and audio of the user interacting in the physical environment and/or the virtual environment), (ii) data from external systems, or (iii) both. The virtual assistant application 505 forwards the data 515 to the virtual assistant engine 510 for processing.

In some embodiments, the data 515 associated with sensors, active information, and/or passive information collected via the client system may be associated with one or more privacy settings. The data 515 may be stored on or otherwise associated with any suitable computing system or application, such as, for example, the social-networking system, the client system, a third-party system, a messaging application, a photo-sharing application, a biometric data acquisition application, an extended reality application, a virtual assistant application, and/or any other suitable computing system or application.

Privacy settings (or “access settings”) for the data 515 may be stored in any suitable manner; such as, for example, in association with data 515, in an index on an authorization server, in another suitable manner, or any suitable combination thereof. A privacy setting for data 515 may specify how the data 515 (or particular information associated with the data 515) can be accessed, stored, or otherwise used (e.g., viewed, shared, modified, copied, executed, surfaced, or identified) within an application (such as an extended reality application). When privacy settings for the data 515 allow a particular user or other entity to access the data 515, the data 515 may be described as being “visible” with respect to that user or other entity. As an example, a user of an extended reality application or virtual assistant application 505 may specify privacy settings for a user profile 525 page that identify a set of users that may access the extended reality application or virtual assistant application 505 information on the user profile 525 page, thus excluding other users from accessing that information. As another example, the virtual assistant application 505 may store privacy policies/guidelines. The privacy policies/guidelines may specify what information of users may be accessible by which entities and/or by which processes (e.g., internal research, advertising algorithms, machine-learning algorithms), thus ensuring only certain information of the user may be accessed by certain entities or processes.

In some embodiments, privacy settings for the data 515 may specify a “blocked list” of users or other entities that should not be allowed to access certain information associated with the data 515. In some cases, the blocked list may include third-party entities. The blocked list may specify one or more users or entities for which the data 515 is not visible.

Privacy settings associated with the data 515 may specify any suitable granularity of permitted access or denial of access. As an example, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. In some embodiments, different pieces of the data 515 of the same type associated with a user may have different privacy settings. In addition, one or more default privacy settings may be set for each piece of data 515 of a particular data-type.

The data 515 may be processed by the interaction module 530 of the virtual assistant engine 510 in a single occurrence, e.g., a single interface input or single activity, or across multiple occurrences, e.g., a dialog or days' worth of activity using various techniques (e.g., manual, batch, real-time or streaming, artificial intelligence, distributed, integrated, normalization, standardization, data mining, statistical, or like processing techniques) depending on how the data 515 is obtained and the type of data 515 to be processed. In certain instances, the data 515 comprises a sequence of perceptions (x₁ . . . , x_{T}) 535 received and processed from the egocentric vision or first-person vision of the user. Egocentric vision entails processing images and videos captured by a wearable camera, which is typically worn on the head or on the chest and naturally approximates the visual field of the camera wearer. The sequence of perceptions (x₁ . . . , x_{T}) 535 may correspond to a few frames of input data received from the client system such as an HMD. A data frame is a data structure for storing data in a data store 540. The data frame includes a list of equal-length vectors. Each element of the list may be interpreted as a column and the length of each element of the list is the number of rows. As a result, data frames can store different classes of objects in each column (e.g., numeric, character, factor, etc.). The data store 540 is one or more repositories for persistently storing and managing collections of data such as databases, files, key-value stores, search engines, message queues, the like, and combinations thereof.

The processing of the data 515 extracts information 542 pertaining to the data and generates a structured representation of the extracted information 542. The information extraction is the process of extracting specific information from the data 515. In some instances, the specific information includes objects, attributes, and relationships between objects in the data 515. The specific information extracted, and the techniques used for the extraction depends on the type of data 515 being processed. For example, if the user input is based on a text modality, the virtual assistant engine 510 may process the input using a messaging platform 545 having natural language processing capabilities to extract the specific information such as determining an intent of the text. If the user input is based on an audio modality (e.g., the user may speak to the virtual assistant application 505 or send a video including speech to the virtual assistant application 505), the virtual assistant engine 510 may process it using an automatic speech recognition (ASR) module 550 to convert the user input into text and use the messaging platform 545 to extract the specific information such as identifying named entities within the text. If the user input is based on an image or video modality, the virtual assistant engine 510 may process it using optical character recognition techniques within the messaging platform 545 to convert the user input into text and use the messaging platform 545 to extract the specific information such as identifying named entities within the text. If the user input is based on gestures and/or user interface actions, the virtual assistant engine 510 may process it using gesture and/or user interface recognition techniques within the processing system 555 (e.g., processing system 120 described with respect to FIG. 1) to extract the specific information such as identifying the gesture or user interface inputs. If the activity is observed by one or more image capture devices, then artificial intelligence platform 560 (e.g., computer vision, image analysis and classification, physical environment mapping, event, action, or task prediction, object detection, and the like) may be used to process the image or video data and extract the specific information such as determine the objects, attributes, and/or relationships between objects within an image observed by the image capture devices. If the activity is sensed by one or more sensors, then artificial intelligence platform 560 may be used to process the sensor data and determine the objects, attributes, and/or relationships detected by the sensors. If the data is received from remote systems, then messaging platform 545, ASR module 550, processing system 555, artificial intelligence platform 560, or a combination thereof may be used to process the remote system data and determine the objects, attributes, and/or relationships received from the remote system. The artificial intelligence platform 560 comprises rule-based systems 562, algorithms 565, and models 567 for implementing rule-based artificial intelligence and machine learning based artificial intelligence.

Once the information 542 is extracted, the interaction module 530 is configured to identify a planning model 577 for a task from a corpus of planning models for various tasks. For example, the data 515 may include a request by the user for assistance in performing a given task (e.g., where a user requests assistance to make pizza and cookies and prepare some drinks for hosting friends over for dinner). The objects and relationships between the objects detected from the data 515 may pertain to the task, where a symbolic task state represents a state that the objects and the relationships between the objects as observed in the data 515 and a desired task goal state is a state that the objects and the relationships between the objects must take in order for the task to be considered completed.

The planning model 577 for the task may be expressed with a domain specific planning language (e.g., Planning Domain Definition Language (PDDL), and the planning model 577 encodes the actions for the task and how the actions impact the objects and the relationships between the objects. For example, given an image, downstream analysis involves not only detecting and recognizing objects in the image, but also learning the relationship between objects (visual relationship detection), and generating a text description for a current task state of the extended reality environment based on the image content. The current task state comprises the objects and relationships between the objects that pertain to the current task (i.e., a substrate of the world state observed within the extended reality environment that pertains to the current task). Moreover, the downstream processing involves the virtual assistant engine 510 defining one or more tasks as a problem such as a planning problem, a temporal planning problem, a task allocation problem, or a combination thereof. These processes require a higher level of understanding and reasoning for image vision tasks. The planning model 577 is a structured representation of the data (e.g., an image) that allows encoding of a problem (e.g., a temporal planning problem) such that the problem can be solved given the current task state.

In some embodiments, the planning model 577 may be generated by the interaction module 530 using artificial intelligence platform 560. For example, algorithms 565 and/or models 567 of the artificial intelligence platform 560 may be configured for object detection such as CNN-based object detection, R-CNN, fast R-CNN, faster R-CNN, Mask R-CNN-based object detection, You Only Look Once (YOLO)-based object detection, and variants thereof or the like. In certain instances, the objects and relationships are detected through one or more neural networks such as Mask R-CNN or a variant thereof known as Detectron or Detectron2 developed by Meta AI. In general, the generation process includes one or more models performing object and relationship detection. Specifically, the object detection layer detects the objects, and a relationship detection layer predicts the relationships between object pairs. For detection of inter-object relationships, context information for the corresponding objects may be used. The context features used in the relationship detection include perceptual features—properties of objects as the visual system represents them—treated as probabilistic estimates of parameters of the scene. The predictions are output as labels for the objects and relationships thereof. The labels are then used to create a symbolic task state for the current task. For example, the labels may be used in logical statements or expressions (e.g., Boolean expressions) that define a symbolic task state in terms of the objects, object relationships (i.e., predicates), and labels.

In some instances, the identification includes using rule-based artificial intelligence and/or machine learning based artificial intelligence to identify a request for assistance and the subject of the request for assistance (e.g., assistance with cooking and mixing a cocktail). The subject of the request is then used to search the data store 540 for planning models 577 pertaining to the same or substantially similar subject(s) (e.g., cooking and mixology). As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent. A set of possible actions 580 are identified and obtained for workflow(s) pertaining to the given scenario. The set of actions 580 may be actions/operator templates 580 pre-defined, encoded, and associated with various tasks or goals that a user can request assistance with via the virtual assistant. The set of possible actions 580 are encoded with one or more action parameters. For example, positional and capacity constraints may be encoded as an explicit user location and assumption (or determined) capacity (e.g., two hands) to execute the tasks. Encoding is the process of putting a sequence of characters (letters, numbers, punctuation, and certain symbols) into a specialized format for efficient transmission or storage.

The interaction module 530 is further configured to generate and populate the planning model 577 based on the current state of the task, the set of actions 580, or a combination thereof. For example, if the current input data 515 includes a sequence of perceptions as an initial interaction for a given scenario (i.e., the input data is the trigger for the virtual assistance), then the interaction module 530 may generate and populate the planning model 577 with the current state of the task and the set of actions 580 because the virtual assistant is establishing a base model for the given scenario. However, if the current input data 515 includes a sequence of perceptions subsequent to the initial interaction for a given scenario (i.e., the input data is a continuation of the interaction as part of the virtual assistance), then the interaction module 530 may update and populate the planning model 577 with only the current state of the task because the virtual assistance has already established the base model for the given scenario. Nonetheless, it should be understood that there are instances where the interaction module 530 may update and populate the planning model 577 with the current state of the task and a revised set of actions 580 (e.g., a new task may be triggered by the subsequent actions of the user and a revised set of actions may be determined based on the task change). The planning model 577 is then stored as metadata with the data 515 in the data store 540.

The optimal guide 585 (also referred to herein as a planner) is configured to construct a plan of various actions for assisting one or more users to achieve their goal (e.g., where a user requests assistance to make pizza and cookies and prepare some drinks for hosting friends over for dinner). The plan is determined based on the planning model 577 of a current task state, and a solution computed for a problem (e.g., a planning problem, a temporal planning problem, a task allocation problem, or a combination thereof) defined within the planning model 577. To solve the problem and develop the plan, one or more temporal planner techniques (temporal planner algorithms) may be used by the virtual assistant as the planner using optimal guide 585 and solver 587 (e.g., the CP-SAT solver from Google OR-Tools). The solution is comprised of a sequence of actions and their duration that optimize for the metrics while respecting constraints, costs, and preferences. The various temporal planner techniques for solving the problem may be classified into two categories: heuristic algorithms that obtain an approximate solution in a short time and optimization scheduling algorithms that obtain an optimal solution. For example, the OPTIC (Optimizing Preferences and TIme-dependent Costs) planner has been demonstrated to be a flexible planner capable of handling hard temporal constraints of ordering and soft temporal constraints related to preferences, while optimizing for a total time metric. Furthermore, OPTIC is a partial order planner implying that it only focuses on solving for actions that are required to respect constraints and minimize costs. Therefore, OPTIC may be used for solving a cooking domain temporal planning problem. OPTIC uses mixed-integer programming (MIP) formulation to solve the planning problem. The MIP seeks to optimize the assignments of timestamps to steps, given the costs of preferences and other terms in the metric, subject to the ordering and capacity constraints (a user might only be able to carry two things at a time with their hands). Other temporal planner techniques that may be used for various activity domains include without limitation a parallelized depth first/implicit heuristic search (PDF/IHS), simulated annealing (SA), list scheduling, critical path (CP), critical path/most immediate successors first (CP/MISF), depth first/implicit heuristic search (DF/IHS), remaining distance including communication overhead (REDIC), evolutionary algorithms (EAs) such as genetic algorithms, genetic programming, differential evolution, and particle swarm optimization, and Multi-Objective Evolutionary Algorithms (MOEAs) such as Pareto Archived Evolution Strategy (PAES) and feed-forward artificial neural network (FFNN).

In some instances, the problem is solved while respecting the constraints, costs, and preferences associated with two or more users, and the solver 587 constructs the plan to include task allocation between multiple users in the right order of steps (optimized manner) to achieve the goal. For example, the solver 587 and the task allocator 590 may work in combination to construct a plan of various actions for assisting the users to achieve their goal based on a number of users, user level experience, skill sets, user preferences, or even location in room for multiple users. This adds in a task allocation problem in addition to the planning problem. The task allocation problem is one where a number of sub-tasks need to be assigned to multiple users at a minimum overall cost (e.g., cost to an optimizing function). The task allocator 590 may use one or more task allocation techniques (task allocation algorithms) in conjunction with the one or more temporal planner techniques (temporal planner algorithms) in order to find the optimal single (e.g., cooking) or multi-task (e.g., cooking and cleaning) procedure for assigning sub-tasks to users and completing the subs-tasks in accordance with an extended reality environment. The one or more task allocation techniques that may be used for various activity domains include without limitation hierarchical planning, multiple objective linear programing (MOLP), mixed-integer linear programming (MILP), EAs such as genetic algorithms, genetic programming, differential evolution, and particle swarm optimization, and MOEAs such as PAES and FFNN. In certain instances, the solver 587 may make a tradeoff between performance of the sub-tasks in a time saving or efficient manner and satisfaction of one or more user preferences or sub-goals. For example, there could be a constraint of sub-goals for providing user A with experience in X task or user A having a preference for washing dishes as opposed to cutting vegetables. The tradeoff between optimization and task assignment may be realized using, for example, a heuristic algorithm as opposed to an optimization scheduling algorithm. As should be understood, in the instance of task assignment for two or more users, the input data 515 would be received as multiple feeds from multiple client systems to determine the current state of the task.

Once the plan is constructed, the virtual content module 592 determines virtual content 595 to be displayed to the user via the client system based on virtual content data 597 in order to present the actions of the plan to the user. In various embodiments, the virtual content data 597 is defined and coded by a developer and included as part of the virtual assistant. For example, a developer may define and code virtual content data 597 for actions in order to assist one or more users with achieving the goals. For example, virtual content data 597 may be defined and coded for the actions, which includes: (i) a glimmer to be positioned and displayed on an object such as an electrical appliance in order to recommend and initiate an action, (ii) an outline of an object or animation of using an object (e.g., a knife for cutting vegetables) to be positioned and displayed on surface in order to recommend and initiate an action, (iii) the various glimmers or outlines with audio or text based instructions on how to perform the actions displayed in the user field of view in order to recommend and initiate an action, and (iv) text based instructions audio or text based instructions on how to perform the actions displayed in the user field of view in order to recommend and initiate an action.

The determined virtual content 595 may be generated and rendered by the virtual content module 592, as described in detail with respect to FIGS. 2A, 2B, 3A, 3B, 4A, 4B, and 4C. For example, the virtual content module 592 may trigger generation and rendering of virtual content 592 by the client system (including virtual assistant application 505 and I/O interfaces 520) based on a current field of view of user, as may be determined by real-time gaze tracking of the user, or other conditions. More specifically, image capture devices of the sensors capture image data representative of objects in the real world, physical environment that are within a field of view of image capture devices. During operation, the client system performs object recognition within image data captured by the image capture devices of HMD to identify objects in the physical environment such as the user, the user's hand, and/or physical objects. Further, the client system tracks the position, orientation, and configuration of the objects in the physical environment over a sliding window of time. Field of view typically corresponds with the viewing perspective of the HMD. In some examples, the extended reality application presents extended reality content comprising mixed reality and/or augmented reality. The extended reality application may render virtual content 595, such as virtual information or objects on a transparent display such that the virtual content 595 is overlaid on real-world objects, such as the portions of the user, the user's hand, physical objects, that are within a field of view of the user. In other examples, the extended reality application may render images of real-world objects, such as the portions of the user, the user's hand, physical objects, that are within field of view along with virtual content 595, such as virtual information or objects within extended reality content. In other examples, the extended reality application may render virtual representations of the portions of the user, the user's hand, physical objects that are within field of view (e.g., render real-world objects as virtual objects) within extended reality content.

### Task Optimization Techniques

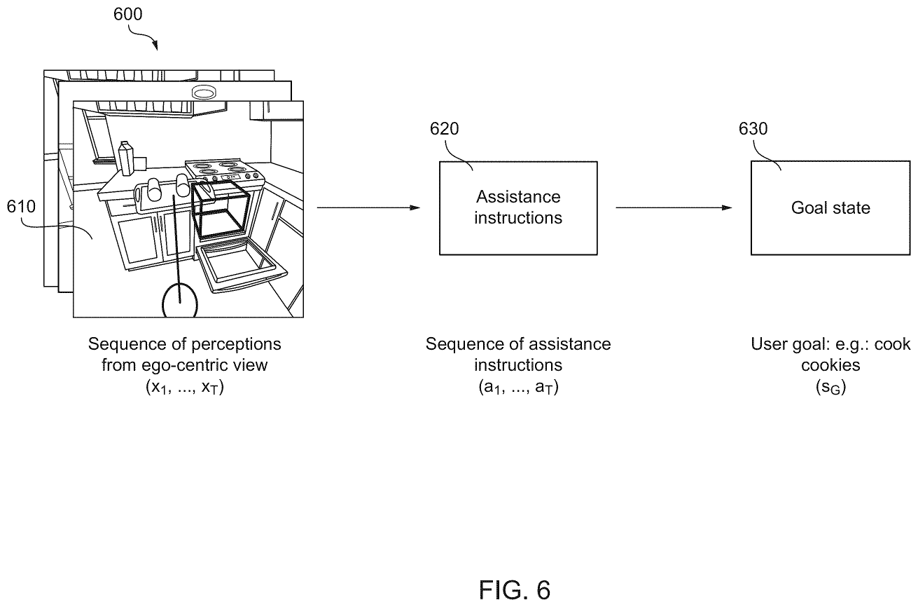

In order to assist users with performing an activity or achieving a goal, a virtual assistant (e.g., the virtual assistant 500 described with respect to FIG. 5) is configured to process input data and generate virtual content to be displayed using, for example, an HMD as described with respect to FIGS. 2A, 2B, 3A, 3B, 4A, 4B, and 4C. In particular embodiments, techniques are disclosed to present an optimal single (e.g., cooking) or multi-task (e.g., cooking and cleaning) procedure for completing subs-tasks in accordance with an extended reality environment. In some instances, the optimal procedure corresponds to the procedure that takes the least amount of time from the start of the activity to the end of the activity, including performance of any auxiliary tasks (e.g., washing and cleaning) performed prior, during, and/or after the end of the primary task (e.g., cooking). In order to determine an optimal procedure, a search is performed, using one or more temporal planner techniques and/or task allocation techniques, for a procedure that includes efficient task allocation (e.g., parallel work) to a user. The search for the optimal procedure is considered as a variation of a task scheduling problem and constructed as shown in FIG. 6 as a planning problem 600. The planning problem 600 takes as input a sequence of perceptions 610 (x₁ . . . , x_{T}) from the egocentric vision of the user, and derives a sequence of actions 620 (a₁ . . . , a_{T}) (also described herein as assistance instructions or a plan) from the sequence of perceptions 610 (x₁ . . . , x_{T}) that minimizes the execution time (procedure length) of parallel processing of a set of n sub-tasks with defined processing time and precedence constraints on m resources to achieve a user goal state 630 (SG) for each task (e.g., cook cookies)(also referred to herein as a task goal state).

Take for example a scenario where a user requests to make pizza and cookies and prepare some drinks for hosting friends over for dinner. The basic goal of this cooking planning problem is to minimize the total time used to prepare and cook, subject to resource constraints and task requirements. Some resource constraints include kitchen equipment settings and locations, manpower (e.g., number of users and hands), etc.; and some task requirements include sub-task priority within a recipe, completion time, etc. The virtual assistant determines and coordinates a sequence of actions with the user to assist with the request and accomplish the goal. The sequence of actions may be presented to the user through various interface solutions for displaying virtual content in an extended reality environment, e.g., as a list that is checked, as world-locked suggestions with the next object to manipulate and a text description, as a demonstration, as an ordered series of instructions, and the like.

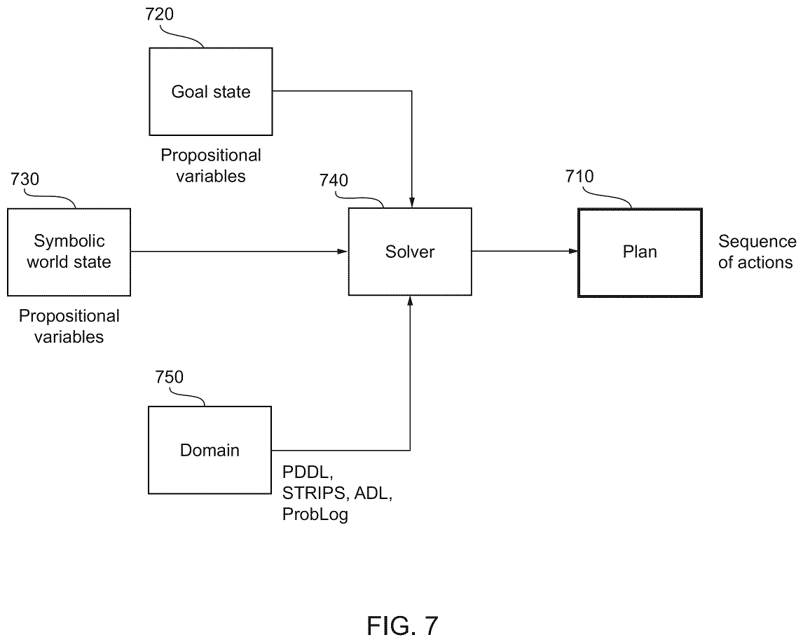

Intuitively, as shown in FIG. 7, the goal of the planning problem is to find the sequence of actions—a plan 710—that enables the user to reach a targeted task goal state 720 starting from an initial state 730 while optimizing with a planner 740 for a set of task requirements or metrics (e.g., minimize task-execution time) and respecting necessary resource constraints (e.g., oven must preheat for 10 minutes before it is warm enough to place in the cookie dough) of a domain 750 (i.e., planning models 577 as described with respect to FIG. 5). While this is similar to a classical artificial intelligence planning problem, what makes the activity domain such as cooking unique and challenging is the nature of the actions. Specifically, the actions in tasks for many activities are durative (they take time to execute e.g., chopping, heating), require certain conditions to be true before execution (e.g., pre-heated oven), have an effort cost associated with them (e.g., distance traveled to the refrigerator), and can occur concurrently. These properties of actions make activities a temporal planning problem. Formally, temporal planning not only requires selecting the order of actions but also their scheduling, given a model of the actions and their effects.

### Formal Definition of Cooking Task as a Planning Problem

A problem instance P in temporal planning may be defined as a quadruple <X, I, A, G> where:
X is a set of state variables s that are propositional in nature,
I: X→{0, 1} the initial state, describing the initial values of state variables,
A is a set of actions over X,
G is the goal, a propositional formula over X.
   In mathematical logic, a propositional variable such as s (also called a sentential variable or sentential letter) is an input variable (that can either be true or false) of a truth function. Propositional variables are the basic building-blocks of propositional formulas, used in propositional logic and higher-order logics.

The action set A is comprised of temporal/durative actions a EA composed of:
d(a): duration.
pres (a), preo (a), pree (a): preconditions of a at start, over all, and at end, respectively.
es(a), ee(a): effects of a at start and at end.
   A temporal plan for P is a set of action-time pairs π={(a₁, t₁), . . . , (aₖ, tₖ)}. Each action-time pair (a, t)∈π is composed of a temporal action a∈A and a scheduled start time t of a, and induces two events startₐ and endₐ with associated timestamps t and t+d(a), respectively. If events are ordered by their timestamp and events with the same timestamp are merged, the result is a concurrent plan π′=A₁, . . . , Aₘ> for the associated planning problem P′=<X, I, A′, G>, where A′={startₐ, endₐ:a∈A}. Also note that, a temporal plan π={(a₁, t₁), . . . , (aₖ, tₖ)} solves P if and only if the induced concurrent plan π′=<A₁, . . . , Aₘ> solves the associated planning problem P′ and, for each (a, t)∈π with startₐ∈Aᵢ and endₐ∈Aⱼ, while respecting the preconditions in the states sᵢ, . . . , sⱼ₋₁ of the state sequence induced by π′.

### Solving the Cooking Domain Temporal Planning Problem

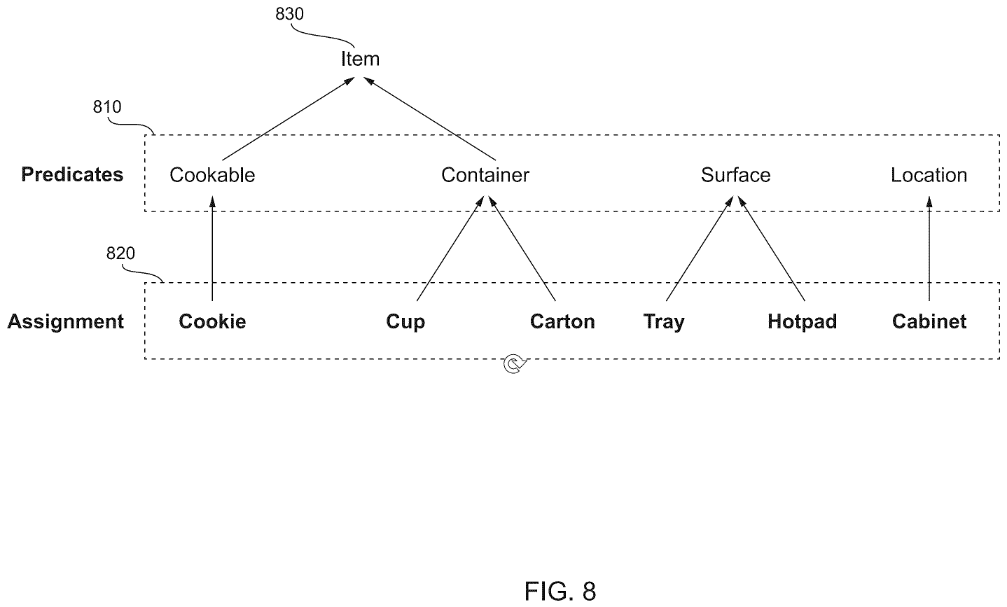

To generate a plan P, two components are needed: 1) a formal way to define the task domain—actions such as cut, put; elements such as ingredients; constraints such as oven pre-heating; and optimality requirements or metrics such as time and effort, and 2) a method to solve for sequence of actions and their times that optimize for the metrics while respecting constraints, costs, and preferences. To formally define the task domain, a domain specific planning language such as STanford Research Institute Problem Solver (STRIPS), Action Description Language (ADL), ProbLog, or Planning Domain Definition Language (PDDL) may be used. In certain instances, PDDL is used as the planning language. PDDL is a Lisp-like, action-centric language that allows encoding of problems that require planning of a sequence of actions to achieve goals. PDDL's domain involves:
objects: things in the world that interest us, e.g.: cookie, cup, jug, milk.
object relationships: properties of objects that that a developer is interested in, e.g.: oven_on, in_oven(item), cooked(item), in(container, liquid).
initial state: the state of the world for the start of the task.
goal specification: things that are to be true.
metrics: things that are to be optimized e.g., total time.
actions/operators: ways of changing the state of the world or a task, can be instantaneous or durative, e.g.,: place_oven(item).
   The objects are atomic units by which a scene (e.g., a scene observed within a sequence of perceptions (x₁ . . . , x_{T}) from the egocentric vision of the user) can be divided. A scene is composed of multiple objects which have associated attributes in the form of object relationships. As shown in FIG. 8, attributes 810 are a characteristic of the objects 820 which affords specific actions, e.g., cookable. A type 830 is a general class of objects 820 with different attributes 810 and affords different kind of actions, e.g., a cookie which is cookable. The object relationships are the attributes 810 that objects 820 can have, e.g., cooked, At, OnTop, On, Warm. A unary object relationship is an attribute 810 that characterizes a single object 820, e.g., cooked. A binary object relationship is an attribute 810 that characterizes a relation between objects 820, e.g., On Top. Domain specific planning language is thus an apt tool to formally define the cooking task temporal planning problem.

### Defining the Task Domain

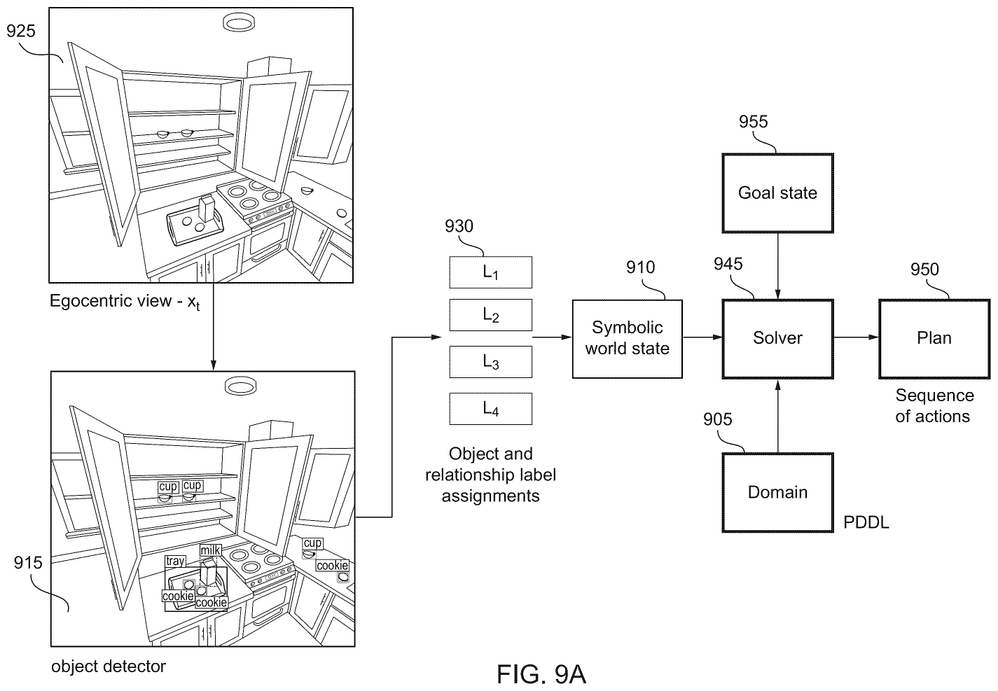

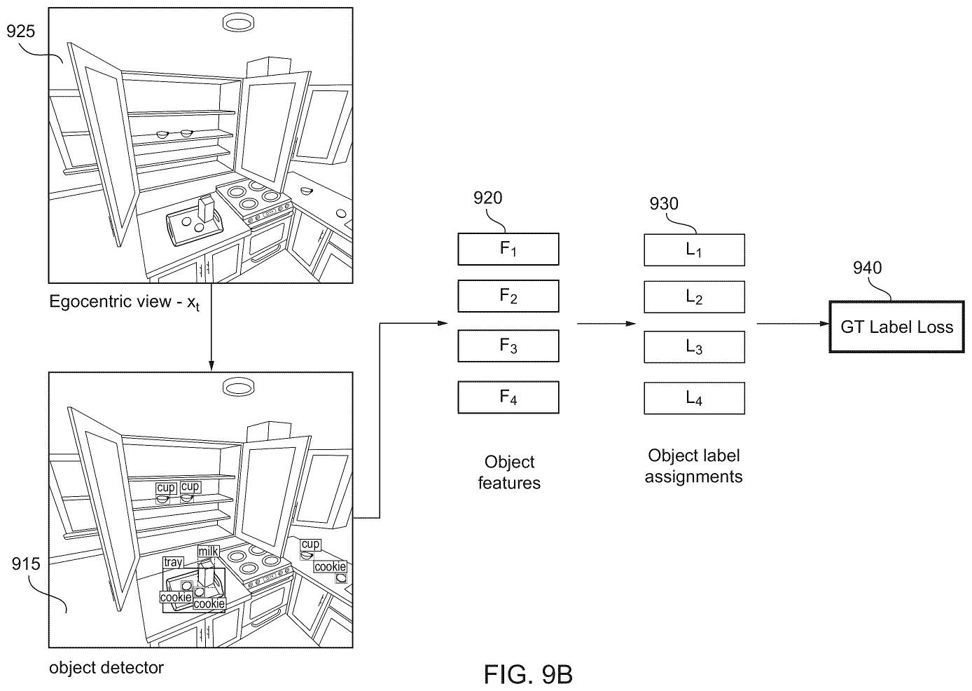

As shown in FIG. 9A, in order to populate the domain specific planning language representation 905 (e.g., PDDL) with a current task state 910 of an extended reality environment, an association of the objects and object relationships with perceptual features (establishing visual meaning) is perceived as a symbol grounding problem. A symbol ground problem pertains to how it is that words (symbols in general) get their meaning. There would be no connection at all between written symbols and any intended referents if there were no minds mediating those intentions, via their own internal means of picking out those intended referents. So the meaning of a word on a page is “ungrounded.” Nor would looking it up in a dictionary help: If a user tried to look up the meaning of a word the user did not understand in a dictionary of a language the user did not already understand, the user would just cycle endlessly from one meaningless definition to another. The user's search for meaning would be ungrounded. In contrast, the meaning of the words in a user's mind—those words one does understand—are “grounded”. That mental grounding of the meanings of words facilitates an association between the words on any external page the user reads (and understands) and the external objects to which those words refer.

With respect to the extended reality environment, mental grounding is used to associate the objects and object relationships with perceptual features (i.e., establish ‘visual meaning’). The visual meaning is inferred using artificial intelligence rather than the user's mind. More specifically, objects are detected using a one or more computer vision models 915 such as Detectron and Detectron2 developed by Meta AI. As shown in FIG. 9B, the object detection comprises extracting object features 920 from the sequence of perceptions 925 (x1 . . . , x_{T}), locating the presence of objects with a bounding box and assigning labels 930 to types or classes of the located objects and their relationships based on the extracted object features 920. In some instances, a simulation platform such as AI Habitat is used to generate training data comprised of sequences of perceptions 925 from a simulated extended reality environment, and the one or more computer vision models 915 are trained using the labels available from the simulation. The training steps executed may comprise iteratively, performing training and validation until the one or more computer vision models 915 has been sufficiently trained for use in the inference phase. For example, for a supervised learning-based model, the goal of the training is to learn of function “h( )” (also sometimes referred to as the hypothesis function) that maps the training input space X to the target value space Y, h: X→Y, such that h(x) is a good predictor for the corresponding value of y. Various different techniques may be used to learn this hypothesis function. In some techniques, as part of deriving the hypothesis function, a cost or loss function 940 may be defined that measures the difference between the ground truth value for an input and the predicted value for that input. The delta between the ground truth value for an input and the predicted value for that input may be used to update the parameters of the one or more computer vision models 915. The update of the parameters may be performed using techniques such as back propagation, random feedback, Direct Feedback Alignment (DFA), Indirect Feedback Alignment (IFA), Hebbian learning, and the like to minimize this cost or loss function 940. After the one or more computer vision models 915 has been trained, the one or more computer vision models 915 may then be stored in a model store where the model can be executed for inferencing or making predictions during the inference or runtime phase based upon real time or inferring data points.

During the inference or runtime phase, the one or more computer vision models 915 output the labels 930 to types or classes of the located objects and their relationships, and the labels 915 are used to create a symbolic task state (i.e., current task state 910). For example, the labels 930 may be used in logical statements or expressions (e.g., Boolean expressions) that define a symbolic task state in terms of the objects, object relationships, and labels. The generating the symbolic task state comprises describing an association of the objects and object relationships (e.g., #_on, in_#(item), cooked(item), in(container, #)) with the perceptual features (the labels) as logical statements. The logical statements may comprise: values (YES and NO, ON and OFF, TRUE and FALSE, IN and OUT, etc.), variables or formulas, functions that yield results, and values calculated by comparison operators. The logical statements may be generated automatically, for example generated, using a truth table generator, a truth table describing the objects and relationships between the objects, and converting, using an expression generator, the truth table to the logical statements. The logical statements may be defined in various programming languages such as in XML, schema definition language (XSDL) or web ontology language (OWL).

Initially, the virtual assistant identifies a workflow pertaining to a given scenario based on the input data (e.g., a sequence of perceptions), the current task state 910, or a combination thereof. Identification of a workflow facilitates an understanding by the virtual assistant of what type of assistance is requested by the user and what that assistance may require such as a set of possible actions for completing a task or goal associated with the workflow. The identification process may include using rule-based artificial intelligence and/or machine learning based artificial intelligence to identify a request for assistance and the subject of the request for assistance. The subject being one or more tasks and/or goals that the user is requesting assistance with performing (e.g., assistance with cooking and mixing a cocktail). The subject of the request is then used to search a data store for one or more workflows pertaining to a same or substantially similar subject(s) (e.g., cooking and mixology). A set of possible actions are identified and obtained from the one or more workflows pertaining to the one or more tasks and/or goals. The set of possible actions may be pre-defined, encoded, and associated with various tasks and goals that a user can request assistance with via the virtual assistant. The set of possible actions are encoded with one or more action parameters.

Once the current task state 910 and workflow(s) have been identified, a domain specific planning language representation 905 is generated and populated based on the current task state 910, set of possible actions, or a combination thereof. The domain specific planning language representation 905 is generated to represent the current domain state and a problem to be solved for achieving the one or more tasks or goals (e.g., cook pizza). The domain specific planning language representation 905 (e.g., a PDDL) is comprised of two parts: the domain definition and the problem definition.

The domain definition contains the domain object relationships (i.e., predicates) and operators (called actions in PDDL—derived from the set of possible actions). The domain definition may also contain types, constants, static facts, and the like. The format of an exemplary domain definition may be:

```
(define (domain DOMAIN_NAME)
  (:requirements [:strips] [:equality] [:typing] [:adl])
  (:predicates (PREDICATE_1_NAME ?A1 ?A2 ... ?AN)
      (PREDICATE_2_NAME ?A1 ?A2 ... ?AN)
        ...)
  (:action ACTION_1_NAME
    [:parameters (?P1 ?P2 ... ?PN)]
    [:precondition PRECOND_FORMULA]
    [:effect EFFECT_FORMULA]
  )
  (:action ACTION_2_NAME
    ...)
  ...)
```

Elements in [ ]'s are optional. Names (domain, predicate, action, et c.) are made up of alphanumeric characters, hyphens (“-”) and underscores (“_”), but there are some planners that allow less. Parameters of predicates and actions may be distinguished by their beginning with a question mark (“?”). The parameters used in predicate declarations (the :predicates part) specify the number of arguments that the predicate should have, i.e. the parameter names do not matter (as long as they are distinct). Predicates can have zero parameters (but in this case, the predicate name is written within parenthesis).

The problem definition contains the objects present in the problem instance, the initial state description and the goal. The format of an exemplary problem definition may be:

(define (problem PROBLEM_NAME)
(:domain DOMAIN_NAME)
(:objects OBJ1 OBJ2 ... OBJ_N)
(:init ATOM1 ATOM2 ... ATOM_N)
(:goal CONDITION_FORMULA)
)

Some planners may require that the :requirements specification appears also in the problem definition (usually either directly before or directly after the :domain specification). The initial state description (the :init section) is a list of all the ground atoms that are true in the initial state. All other atoms are by definition false. The goal description is a formula of the same form as an action precondition. All predicates used in the initial state and goal description should naturally be declared in the corresponding domain. In contrast to action preconditions, however, the initial state and goal descriptions should be grounded, meaning that all predicate arguments should be object or constant names rather than parameters.

The domain specific planning language representation 905 including the domain definition and the problem definition are populated with the labels based on the current task state 910 and the set of possible actions pertaining to the given scenario (e.g., where a user requests assistance to make pizza and cookies and prepare some drinks for hosting friends over for dinner). For example, an automated tool such as OWL2PDDL may be used to automatically and dynamically populate domain specific planning language files from the current task state 910 in order to generate a domain specific planning language representation 905.

### Solving for a Sequence of Actions in Multi-Step Processes

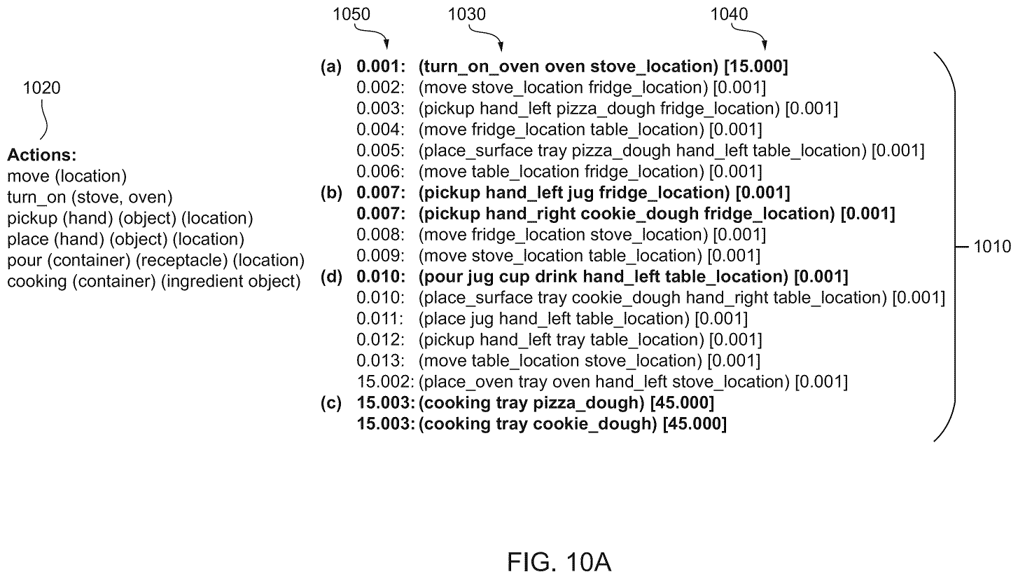

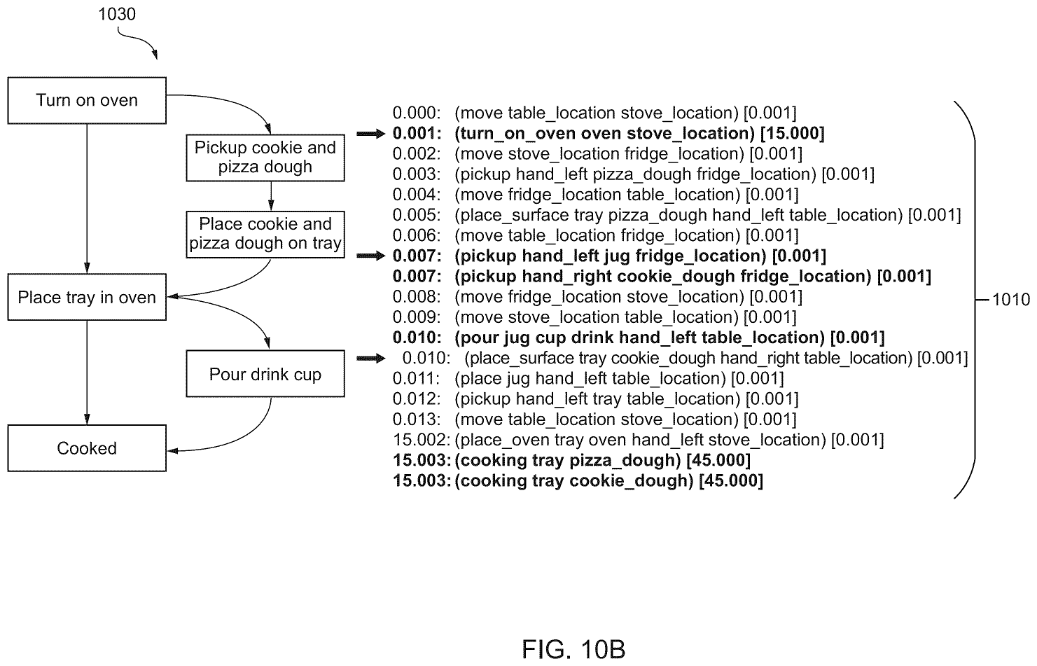

FIGS. 10A and 10B show an exemplary plan 1010 (e.g., plan 950 described with respect to FIG. 9A) comprising a sequence of actions to perform the task and achieve the goal. The plan 1010 is generated from a domain specific planning language representation of a current domain and temporal planning problem P. The current domain and temporal planning problem P are defined based on a set of state variables, an initial state comprised of initial values for a set of state variables derived from a symbolic task state, a set of actions 1020, and a goal. The plan 1010 comprises actions 1030 generated by solving the temporal planning problem for a sequence of actions and duration of the actions that optimize for one or more metrics while respecting constraints, costs, and preferences for the current domain. To solve the temporal planning problem, one or more temporal planner techniques (temporal planner algorithms) are used by the virtual assistant as the planner. The constraints, costs, and preferences include, for example, (i) temporal (action durations 1040), (ii) capacity (user has one or more hands and can only use either the left or right hand), (iii) distance (user pays cost proportional to the distance travelled between locations), and (iv) preferences (explicit action costs such as a user has a preference to wash all utensils as they are used). The actions 1030 are expressed in the plan 1010 with the duration 1040 such as warming up the oven or cooking. The numbers in [brackets] on the right side of the plan 1010 represent the duration 1040 of each action 1030. For the sake of demonstration, most actions are considered to have a duration of 0.001 timesteps, longer actions, warming up oven and cooking, have a duration of 15 and 45 timesteps respectively. However, it should be understood that the duration 1040 is not limited to these specific timesteps. The plan 1010 is executed in accordance with a temporal ordering determined by the planner and represented by the numbers 1050 on the left side of the actions 1030.

As highlighted in bold and illustrated in FIGS. 10A and 10B, the plan 1010—(a) ensures that the user preheats the oven at the right time so as to not wait for it later, (b) combines steps requiring meal prep such as retrieving ingredients from the refrigerator and utensils from cupboards, (c) suggests baking cookies and pizza in the oven simultaneously so that the user can make efficient use of the oven, and (d) recommends the user to prepare drinks in the meantime. These sub-task optimizations ensure that the user can accomplish the task of preparing a set of dishes in the least amount of time and effort.

### Visualizing the Sequence of Actions

Once the current task state is known and the plan is computed, the sequence of actions may be visualized with virtual content presented to the user via the client system based on virtual content data. An extended reality application may render the virtual content, such as virtual information (e.g., action recommendations) or objects on a transparent display such that the virtual content is overlaid on real-world objects, such as the portions of the user, the user's hand, physical objects, that are within a field of view of the user. In other examples, the extended reality application may render images of real-world objects, such as the portions of the user, the user's hand, physical objects, that are within field of view along with virtual content, such as virtual information (e.g., action recommendations) or objects within extended reality content. In other examples, the extended reality application may render virtual representations of the portions of the user, the user's hand, physical objects that are within field of view (e.g., render real-world objects as virtual objects) within extended reality content. Moreover, because the sequence of actions from input of the sequence of perceptions to output of the virtual content for the sequence of actions is executed every few frames of input data, the overall virtual assistance can be replanned and adapted dynamically or on the fly based on the user and their actions in the artificial virtual environment.

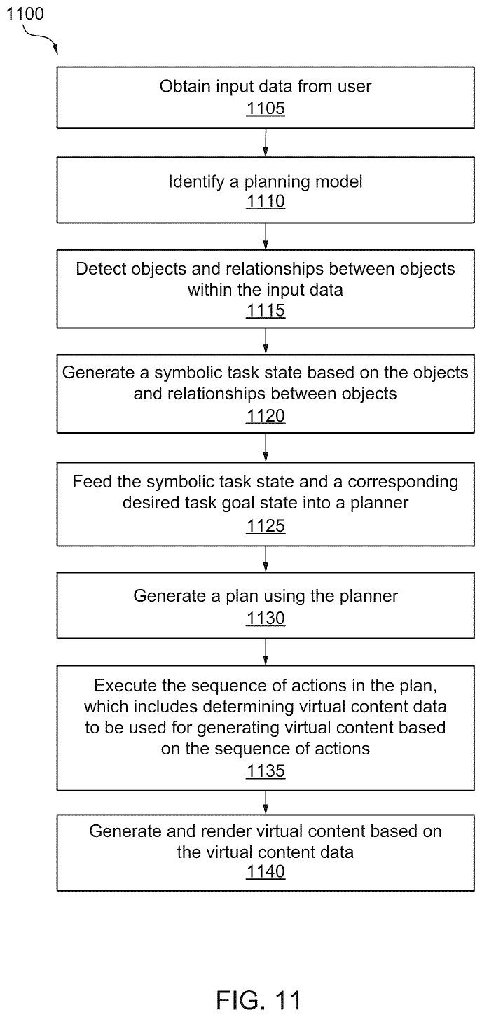

FIG. 11 is a flowchart illustrating a process 1100 for assisting users with performing a task or achieving a goal according to various embodiments. The processing depicted in FIG. 11 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 11 and described below is intended to be illustrative and non-limiting. Although FIG. 11 depicts the various processing steps occurring in a particular sequence or order, this is not intended to be limiting. In certain alternative embodiments, the steps may be performed in some different order, or some steps may also be performed in parallel. In certain embodiments, such as in an embodiment depicted in FIGS. 1, 2A, 2B, 3A, 3B, 4A, 4B, 4C, and 5, the processing depicted in FIG. 11 may be performed by a client system implementing a virtual assistant to assist users with performing an activity or achieving a goal.

At step 1105, input data is obtained from a user. The input data includes: (i) data regarding activity of the user in an extended reality environment (e.g., images and audio of the user interacting in the physical environment and/or the virtual environment), (ii) data from external systems, or (iii) both. The data regarding activity of the user in an extended reality environment includes an explicit or implicit request by the user for assistance in performing a task (e.g., baking a pizza). The input data may be obtained by a client system that comprises at least a portion of the virtual assistant. In certain instances, the client system is an HMD as described in detail herein. In some instances, the data regarding activity of the user includes a sequence of perceptions from the egocentric vision of the user.

At step 1110, a planning model for the task is identified from a corpus of planning models for various tasks. The planning model for the task is expressed with the domain specific planning language, and the planning model encodes the actions for the task and how the actions impact objects and the relationships between objects.

At step 1115, objects and relationships between the objects within the input data are detected using one or more computer vision object detector models (object detection models). The objects and relationships between the objects pertain to the task. The one or more object detector models may be one or more machine learning models such as a CNN, a R-CNN, a fast R-CNN, a faster R-CNN, a Mask R-CNN, a You Only Look Once (YOLO), Detectron, Detectron2, or any combination or variant thereof. The object detection comprises extracting object features from the input data for the task, locating the presence of objects with a bounding box and assigning labels to types or classes of the located objects and relationships between the located objects based on the extracted object features. The one or more object detection models output the labels to types or classes of the located objects and relationships between the objects. The labels for the objects and relationships between objects are a set of state variables that are propositional in nature (propositional variables) for the current state of the world as observed by the user.

At step 1120, a symbolic task state is generated based on the objects and the relationships between the objects. The generating the symbolic task state comprises describing an association of the objects and object relationships with the perceptual features (the labels) as logical statements (e.g., Boolean expressions). The logical statements may comprise: values (YES and NO, and their synonyms, ON and OFF, TRUE and FALSE, etc.), variables or formulas, functions that yield results, and values calculated by comparison operators.

At step 1125, the symbolic task state and a corresponding desired task goal state are fed into a planner using the domain specific planning language. The corresponding desired task goal state is a state that the objects and the relationships between the objects must take in order for the task to be considered completed.

At step 1130, a plan is generated using the planner. The plan includes a sequence of actions to perform the task and achieve the corresponding desired task goal. The sequence of actions optimizes for one or more metrics while respecting constraints, costs, and preferences for the task. In instances where the problem being solved by the planner comprises a temporal planning problem, the plan is generated by solving the temporal planning problem for a sequence of actions and a duration of the actions that optimize for one or more metrics while respecting constraints, costs, and preferences for the current domain. The sequence of actions is a temporal ordering of the actions.

At step 1135, the sequence of actions in the plan is executed. In some instances, the sequence of actions is executed in accordance with the temporal ordering and duration of the actions. The executing the sequence of actions comprises determining virtual content data to be used for rendering virtual content based on the sequence of actions. The actions are associated with virtual content data defined and coded for the actions in order to assist the user with performing the task and achieving the goal. Determining the virtual content data comprises mapping the actions to respective action spaces and determining the virtual content data associated with the respective action spaces.

At step 1140, the virtual content is generated and rendered by the client system in the extended reality environment displayed to the user based on the virtual content data. The virtual content presents instructions or recommendations to the user for performing at least some of the sequence of actions based on the plan.

The processes described with respect to steps 1105-1140 may be executed every few frames of input data, in order for the overall virtual assistance to be replanned and adapted dynamically or on the fly based on the actions of the user in the artificial virtual environment.

### Multiuser Task Allocation Techniques

In some embodiments, an aggregator is modeled as a planner (e.g., at least part of the optimal guide 585 as described with respect to FIG. 5) for allocating and scheduling tasks amongst multiple users. The aggregator techniques described herein support key features including: (a) user's soft preferences and hard constraints for certain tasks, (b) partial ordering constraints between tasks, (c) collaboration on a task from multiple users, and (d) re-planning to accommodate deviations from previously generated plans. The multiuser task allocation problem is described in detail herein as being modeled using a Vehicle Routing Problem framework and employs a constraint-satisfaction solver to generate optimal (and/or feasible) solutions for allocating and scheduling tasks amongst multiple users.

### Background on Multiuser Task Allocation

Human brains are immensely intelligent machines and enable them to devise intricate plans to achieve complex goals. As described in herein, there is a desire to offload the cognitive burden on the human brain by implementing the CHAI. The implementation of this interface is to be achieved via a meta-AI agent such as the virtual assistant or conductor. Since achieving complex human goals often requires accomplishing multiple tasks, the virtual assistant relies on a large ecosystem of AI agents, namely optimal guides or planners, to guide users in achieving their goals. However, optimal guides are typically designed to provide guidance on a single task and having to perform multiple tasks as described herein naturally leads to the requirement of an aggregator to bring all the tasks together. Such an aggregator should be capable of generating a plan to allocate the tasks to multiple players/users (if in a multiplayer setting), schedule all the tasks for each user, and synchronize the per-task optimal guides in their effort.

By way of example, imagine that a user and their roommate are planning a party. This would require performing multiple tasks before the guests arrive and it can be very overwhelming to distribute them amongst the user and their roommate, and then finish them on time. A typical list of such tasks can look like those in Table 1. To make matters worse, the user's roommate may not be a great cook and might have less motivation to work on the cooking tasks. The user, on the other hand, might not like to clean much and would want to take such soft preferences into account while allocating tasks amongst themselves. Further, some tasks might have hard constraints like reaching up to high places like kitchen shelves which only the user or the roommate might be tall enough to accomplish. Yet other tasks like, moving a piano, might require both the user and their roommate to simultaneously collaborate on them. Lastly, extra tasks might come during execution, for instance, if the user's guests text to ask for parking instructions and need to be responded to with instructions. Planning in such complex settings is a challenging problem and the planner and aggregator described herein were developed to address these challenges and others.

TABLE 1
A sample task list for party planning
TO DO list

| | |
|---|---|
| [organize] | Chill drinks in the fridge |
| [organize] | Label food with allergy reminders (e.g. for peanut ingredients) |
| [cook] | Take bread out of the oven |
| [cook] | Put popcorn in the oven when available with a 2 min timer |
| [cook] | Take-out popcorn from the oven when done |
| [cook] | Put cookies in the oven when oven is available |
| [cook] | Set up a 20 min timer for the cookies |
| [clean] | Clean up a few dirty areas on the living room floor |
| [clean] | Tidy up the couch |
| [clean] | Move the piano from living room to store |
| [cook] | Turn off the stove in 8 minutes |
| [organize] | Update list of items the guests are bringing |
| [organize] | Reply to the guest's messages |
| | (e.g. send them parking instructions) |

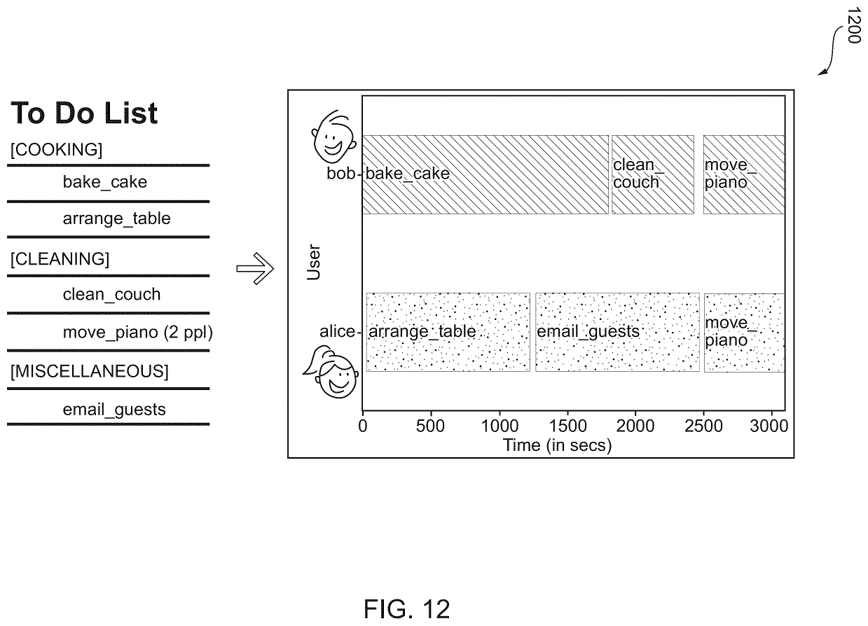

Specifically, described herein is a planning algorithm which generates plans to allocate a list of spatially distributed tasks amongst multiple users (see FIG. 12 illustrating the planner allocating tasks to multiple users on a timeline). The planning algorithm assumes that the users are capable of performing the tasks either by themselves if the tasks are simple, or by using other specialized optimal guides for complex tasks. The modeling approach for the planner supports the following key features:
Multiuser: The planner can allocate multiple tasks amongst multiple users.
Spatially distributed tasks: The planner can model tasks at distinct spatial locations, travel time between task locations and can also support motion within a task.
User preferences: The planner can optimize for user's soft preferences for certain kinds of tasks, e.g., a person may prefer to organize but not cook.
User constraints: The planner never allocates tasks to users if they are unable to satisfy all the hard constraints for certain tasks, e.g., a task might require lifting heavy objects.
Partial ordering: The planner can support partial ordering constraints between tasks, often required for pick-up and drop-off tasks.
Collaboration: The planner offers support for multiple players collaborating on the same task at a time, e.g., moving a piano to another room.
Carrying capacities: The planner allows modeling players' carrying capacity, thereby at times, al¬lowing them to pick up multiple objects before dropping them off
Accommodating deviations: The planner provides support for a repeated-call mode to re-plan and accommodate deviations from previously generated plans.
New tasks: Often while executing a plan, new tasks can pop-up, e.g. responding to friends' texts about parking instructions. While re-planning, the planner also supports adding new tasks.

The planner is agnostic to what comprises a specific task and thus does not break down complex tasks any further. For instance, if one of the tasks is “tide up the couch”, the planner will schedule the task as an atomic task, unless a cleaning optimal guide first decomposes the compound task into its constituent steps, formats them as needed by the planner and then replaces the task “tidy up the couch” in the planner's input with the constituent tasks. Hence, the planner does not need to capture object states or task structure at all. However, coupled with specialized optimal guides for complex tasks, which can perform this breakdown, the planner can also interleave steps from different complex tasks to achieve further efficiency.

### Understanding the General Problem of Multiuser Task Allocation

The set of all tasks may be denoted by T and the set of all users be denoted by U. The goal is to allocate each task to one (or more, if required) of the |U| users. For the purpose of task scheduling (top-down maps), it is assumed that the environment where the tasks are being performed is known. Specifically, the availability of the following is assumed:
3D Map: A 3D map of the environment detailing all available empty space, house boundaries and marking space occupied by obstacles.
Path Planner: A path planner which takes two 3D locations and returns the shortest distance (and optionally the shortest path) between them on the given 3D map.

For tasks, the j^{th} task is characterized by the following inputs:
1. Task start location (ls,j): 3D coordinates where the task begins.
2. Task end location (le,j): 3D coordinates where the task ends (since several tasks, e.g. moving a piano, can start and end in different locations).
3. Average task duration (dj): While users can take variable amounts of time in doing different tasks, the known average task durations may be assumed.
4. Task type: Each task belongs to one of N known types. This type helps us identify whether the task is preferred by a certain user.
5. Task constraints (cj): Each task can have constraints that the user may need to agree a priori to be capable of, e.g., lifting heavy objects alone. The model assumes the L global constraint types and each task may require some or all of them. Hence, cj is a binary vector of length L whose i^{th} entry being 1 indicates whether the j^{th} task requires the i^{th} constraint to be agreed to by the user.
6. Task requirements (rj): Number of users required to simultaneously work on the task.
7. User capacity requirements (creqj): Carrying capacity required by the user/(s) working on this task. For instance, certain tasks might require the user to have both hands available.
8. User capacity changes (δcj): Change in carrying capacity made to each user working on the task after the task ends. This is useful in modeling object pick-up tasks which end up occupying a user's hand/(s) even after the current task ends, until the picked up object is dropped off elsewhere by another subsequent task.

For users, the k^{th} user is characterized by the following inputs:
1. Initial location (l^{k}): 3D coordinates of the user's initial location.
2. Speed (v^{k}): User's average moving speed on the map.
3. User preferences: The k^{th} user is assumed to hold a binary preference for each possible task type. Each user's preference may be queried for all the N task types before starting the planning. Since each task has a unique task type, a preference matrix P:{0, ^{1}|T|><|U|} may then be computed whose entry p^{k}ⱼ is 1 if the k^{th} user prefers the j^{th} task and 0 otherwise. Note that this binary model of preferences is followed to allow users' preferences to be elicited via a simple multiple-choice question. Having more complex real-valued or ranking-based models of utility will require eliciting relative utility values from users, which can be tedious and time consuming.
4. User constraints: The k^{th} user is also assumed to hold a binary response to each of the L possible task constraint requirements which can be queried for all users before starting the planning. Hence, a priori a constraint matrix C:{0, ^{1}|T|><|U|} may be computed whose entry c^{k}ⱼ is 1 if the k^{th} user agrees to all the constraints required for the j^{th} task.
5. Max capacity (cmax^{k}): Maximum carrying capacity of the k^{th} user (generally set to 2 to represent two available hands).
6. Initial capacity (cinit^{k}): Initial carrying capacity of the k^{th} user.

For temporal and ordering constraints, optional absolute and relative temporal constraints may be input on tasks:
1. Absolute temporal constraints: These allow specifying direct equality or inequality constraints on desired start and end times of tasks.
2. Relative ordering constraints: These express partial ordering constraints between tasks, i.e., certain tasks cannot begin till certain other tasks have ended.

For allocation constraints, certain tasks may be allocated to specific users. Additionally or alternatively, inputting constraints may be allowed on pairs of tasks which force them to be allocated to the same user.

The desired output plan from the planning algorithm (planner) comprises an allocation plan and an execution plan. Specifically, given the set of users U and the set of tasks T, a set B=U∪T is initially defined to represent the two sets jointly since it'll help address the travel between various locations (e.g., user-to-task or task-to-task) compactly. The job of the planning algorithm is then two-fold:
1. Allocate each task to one (or more, if needed) user/(s)
2. For each user, schedule all their tasks into an execution plan

Allocation Plan: A routing tensor X: {0, 1}|B|><|T|><|U|, is defined whose entry x^{k}ᵢⱼ is 1 if the k^{th} user travels directly from location i to location j. Note that the domain of index i is the set B since the k^{th} user can be traveling from either their initial location or an intermediate task location. However, after starting to move they will never need to return back to any of the initial user locations, hence, the domain of index j is the set of all tasks T. The planner's aim will be to only allow a user to travel to index j if the j^{th} task is allocated to user k (enforced via subsequent formulation constraints). Hence, the allocation of the j^{th} task to the k^{th} user can be computed as a^{k}ⱼ=>i∈B xkij and takes the value 1 if the jth task is allocated to the k^{th} user and 0 otherwise.

Execution Plan: To obtain an execution plan, a start time (sj) and an end time (ej) are defined for the j^{th} task. The vectors of all start and end times can be represented as s and e respectively.

Hence, overall the planning algorithm needs to compute the routing tensor X and the start and end time vectors s and e for all tasks to specify a complete solution. X s, e together provides the task allocation, ordering and start/end timestamps which can be stitched into an execution plan for each user.

### Routing-Based Formulation

Having defined the inputs to the planner and the expected solution variables to be outputted, the planning problem is thereafter formulated as a constraint satisfaction problem under the Vehicle Routing Problem framework.

Travel distances: First pairwise distances are computed between all locations of interest. Define _{δij} Vi E B, j E T as the shortest path distance between location of element i and the location of task j as computed using the shortest path planner on the 3D map. Since the first index i can correspond to a user or a task in B, the user's initial location lⁱ can be used if i corresponds to a user or the task's end location _{le,i} can be used if i corresponds to a task. However, the second index j corresponds to a task in T and the start location of the _{task/s,j}. can be used. This lets the asymmetry be incorporated in travel distances induced by tasks starting and ending at different locations (e.g., moving a piano). Note that consequently, _{δij} may not equal δji (assuming i corresponds to a task) and _{δjj} may not be zero for a task j which has different start and end locations.

Plan horizon: The plan execution may be assumed to begin at time t0. Then the maximum plan duration can be upper-bounded by computing the sum of: (a) all task durations, (b) maximum travel time from a user's initial location to any task location, and (c) the maximum distance from each task to any other task divided by the slowest user's speed. This upper-bound may be computed and represented as horizon H. The planning algorithm is further configured to ensure that any Ordering and Temporal Constraints imposed (see Equations (20)-(21) and the associated description herein) are accounted for by: (1) adding all relative temporal delays _{Δij} specified via Equation (21) to H, and (2) adding to H the largest Δj from Equation (20).

Capacity variables: Additionally, a capacity matrix Cap: ^{Z|B|×|U|} may be defined. This contains capacity variables cap^{k}ᵢ:{0, 1, . . . , cmax^{k}}, Vi E B, k E U to keep track of the k^{th} user's residual capacity after finishing at location i E B. These variables should be computed along with X, S, E variables to fully define the plan, but don't form a part of the desired output.

To compute the optimal plan, a goal is to optimize for two objectives:
1. Time taken to finish all the tasks. Note that this differs from the total time taken by all the users together since users are operating in parallel.
2. The discomfort caused to users due to being assigned tasks outside of their preferences.

Hence, the following objective function (Equation (1)) is optimized:

$${min}_{X , s , e} \{ {max}_{j ϵ T} {e}_{j} + λ {max}_{k ϵ U} \{ {\sum }_{j ϵ T} {\sum }_{i ϵ B} {x}_{{i}_{j}}^{k} ( 1 - {p}_{j}^{k} ) {d}_{j} \} \} \qquad ( 1 )$$

The weighting coefficient (λ E R⁺) controls the trade-off between the above two objectives. Setting λ=1 makes users agnostic to taking up tasks outside of their preferences, if doing so leads to a direct reduction in the overall plan duration. Setting λE [0,1] prioritizes finishing earlier while λ E [1, ∞) prioritizes avoiding users working on tasks outside their preferences. This hyperparameter can be set by developers or averaged after querying from users a priori.

The above objective function (Equation(1)) is minimized subjective to constraints which define the variable domains, ensure travel path continuity for users, ensure collaboration and task requirements and impose temporal ordering. The full optimization problem is provided below and a description of the formulation constraints.

$$\# Objective$$

$${min}_{X , s , e , Cap} \{ {max}_{j ϵ T} {e}_{j} + λ {max}_{k ϵ U} \{ {\sum }_{j ϵ T} {\sum }_{i ϵ B} {x}_{{i}_{j}}^{k} ( 1 - {p}_{j}^{k} ) {d}_{j} \} \} \qquad ( 1 )$$

$$s . t .$$

$$\# Domain Constraints$$

$${x}_{{i}_{j}}^{k} ϵ \{ 0 , 1 \} , ∀ i ϵ B , j ϵ T , k ϵ U \qquad ( 2 )$$

$${s}_{j} ϵ [ {t}_{0} , {t}_{o} + H ] ∀ j ϵ T \qquad ( 3 )$$

$${e}_{j} ϵ [ {t}_{0} , {t}_{o} + H ] ∀ j ϵ T \qquad ( 4 )$$

$${cap}_{i}^{k} ϵ [ 0 , {cmax}^{k} ] , ∀ i ϵ B , k ϵ U \qquad ( 5 )$$

$$\# Path Continuity Constraints$$

$${x}_{ii}^{k} = 0 , ∀ i ϵ T , k ϵ U \qquad ( 6 )$$

$${\sum }_{i ϵ B} {x}_{{i}_{j}}^{k} \leq 1 , ∀ i ϵ T , k ϵ U \qquad ( 7 )$$

$${\sum }_{j ϵ T} {x}_{{i}_{j}}^{k} \leq 1 , ∀ i ϵ B , k ϵ U \qquad ( 8 )$$

$${\sum }_{j ∈ T} {x}_{hj}^{k} \leq {\sum }_{i ∈ B} {x}_{ih}^{k} , ∀ i ϵ b , k ϵ U \qquad ( 9 )$$

$${\sum }_{i ∈ U \backslash \{ k \}} {\sum }_{j ∈ T} {x}_{ij}^{k} = 0 , ∀ k ϵ U \qquad ( 10 )$$

$$\# Collaboration and Player Constraints$$

$${\sum }_{k ϵ U} {\sum }_{i ϵ B} {x}_{{i}_{j}}^{k} = {r}_{j} , ∀ j ϵ T \qquad ( 11 )$$

$$( 1 - {c}_{j}^{k} ) ( {\sum }_{i ϵ B} {x}_{{i}_{j}}^{k} ) = 0 , ∀ k ϵ U , j ϵ T \qquad ( 12 )$$

$$\# Task Planning Constraints$$

$${e}_{j} = {s}_{j} + {d}_{j} , ∀ j ϵ T \qquad ( 13 )$$

$${e}_{i} - {s}_{j} + \frac{{δ}_{ij}}{{v}^{k}} \leq Z ( 1 - {x}_{ij}^{k} ) , ∀ k ϵ U , i ϵ T , j ϵ T \qquad ( 14 )$$

$${t}_{o} - {s}_{j} + \frac{{δ}_{ij}}{{v}^{k}} \leq Z ( 1 - {x}_{ij}^{k} ) , ∀ k ϵ U , i ϵ T , j ϵ T \qquad ( 15 )$$

$$\# Capacity Constraints$$

$${cap}_{k}^{k} = {cinit}^{k} , ∀ k ϵ U \qquad ( 16 )$$

$${creq}_{j} - {cap}_{i}^{k} \leq Z ( 1 - {x}_{ij}^{k} ) , ∀ k ϵ U , i ϵ B , j ϵ T \qquad ( 17 )$$

$${cap}_{j}^{k} - {cap}_{i}^{k} - δ {c}_{j} \leq Z ( 1 - {x}_{ij}^{k} ) , ∀ k ϵ U , i ϵ B , j ϵ T \qquad ( 18 )$$

$${cap}_{k}^{k} + δ {c}_{j} - {cap}_{j}^{k} \leq Z ( 1 - {x}_{ij}^{k} ) , ∀ k ϵ U , i ϵ B , j ϵ T \qquad ( 19 )$$

$$\# [ Optional ] Ordering and Temporal Constraints$$

$$[ {s}_{j} or {e}_{j} ] [ = or \geq or \leq or > or < ] {Δ}_{j} , for pre - specified indices j ϵ T \qquad ( 20 )$$

$${s}_{i} \geq {e}_{j} + {Δ}_{ij} , for pre - specified pairs i , j ϵ T \qquad ( 21 )$$

$$\# [ Optional ] Allocation Constraints$$

$${\sum }_{i ϵ B} {x}_{ij}^{k} = 1 , for pre - specified pairs j ϵ T , k ϵ U \qquad ( 22 )$$

$${\sum }_{i ϵ B} {x}_{ij}^{k} = {\sum }_{i ϵ B} {x}_{{ij}^{′}}^{k} , ∀ k ϵ U and for pre - specified pairs j , {j}^{′} ϵ T \qquad ( 23 )$$

Domain Constraints: Equations (2)-(5) define the domains of the solution variables X, s, e and Cap. Since this is an integer program, start and end times can take only integer values in [t0, t0+H] and capacities can also take only integer values in [0, cmax^{k}].

Path Continuity Constraints: Equations (6)-(10) define constraints which ensure path continuity for users. Specifically, Equation (6) disallows self-loops for entering and exit any task location. Equation (7) ensures that all task locations are entered at most once. Equation (8) ensures that all task and user locations are exited at most once. Equation (9) ensures that no task location h is exited without being entered first. Equation (10) ensures that each user can only exit their own initial location.

Collaboration and User Constraints: Equation (11) ensures that the required number of users are allocated to each task and Equation (12) ensures that no user is allocated any task for which they do not meet all hard constraints.

Task Planning Constraints: Equation (13) ensures that start and end times of a task differ by the average task duration. Equations (14)-(15) ensures that if any user travels between two locations, then they spend at least the required travel time. Note that Z is a large integer constant used to linearize the if-then clause required for the above two equations. Further, the floating-point travel time values δij vk are round-up to the nearest integer since the formulation is an integer program.

Capacity Constraints: Equation (16) initializes the capacity of all users at their start locations to their initial carrying capacity. Equation (17) checks that a user's residual capacity after i is ≥ that required for task j if the user travels from i to j. Equation (18)-(19) are inequalities which together impose the residual capacity update equality, i.e., the residual capacity of a user traveling from i to j must get updated by task j's capacity update δcj.

[Optional] Ordering and Temporal Constraints: Equation (20) allows imposing absolute temporal constraints on specific start and end time values for certain tasks. Equation (21) allows specifying partial ordering constraints between task-pairs i and j, optionally also separating their scheduling by a delay of at least _{Δij} seconds.

[Optional] Allocation Constraints: Equation (22) allows assigning a task j∈T to a specific user k∈U. Equation (23) allows imposing constraints on pairs of tasks such that each task in the pair must be allocated to the same user. These along with partial ordering constraints are often helpful for specifying object pick-up and drop-off tasks. Since if a user picks up an object, that same user must drop it off later. Note that this constraint on a task pair (j, j′) implicitly requires the user requirements of both tasks to be the same, i.e. rj=rj′, otherwise it will make the plan infeasible.

The optimization problem is encoded as an integer constraint satisfaction problem as defined above and then solved using a tool for solving integer programming problems such as the CP-SAT solver from Google OR-Tools. Since this is a variant of the Vehicle Routing Problem, it is in general an NP-hard problem. Thus, finding the optimal solution is often not possible for large problem instances and in such cases the solver may be terminated after a reasonable amount of search time with only a feasible solution obtained.

While the planner is intended to be for single-call memoryless planning, it also partially supports a continuous planning mode. This is useful if the planner needs to be called repeatedly to handle deviations from previously computed plans. The idea is to keep the ongoing tasks of users intact across repeated calls to the planner, since the planner has no memory of previous plans. While deviations can happen for many reasons, three primary use-cases may be supported for deviations:
1. A user j may perform a task faster or slower than the designated average duration dj.
2. New unexpected tasks might appear during execution, which need to be planned for.
3. A user may pick up a different task than suggested by the plan so the existing plan needs to be revised.
   Essentially, the planner requires inserting any new tasks and their relevant constraints, and deleting all the finished tasks and modifying (or deleting) their related constraints appropriately. It further requests each user's last ongoing task before the new plan execution time t0. Formulation-wise, there are two key differences when the planner is executed repeatedly. If a user k's last ongoing task j0 before the new planning time to is provided, then:
1. ₓₖₖⱼ₀ is set to 1 in the re-computed plan.
2. User k is assumed to be at the task location already, so eq 15 is no longer imposed for xkkj0. Apart from the above two modifications, the remaining formulation holds as defined previously.

### Results

### Simple Case

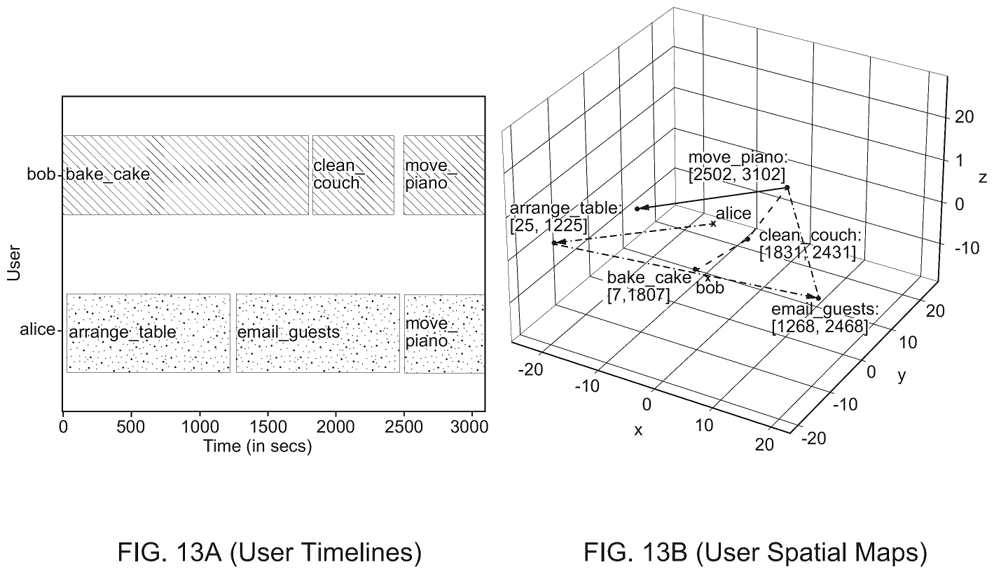

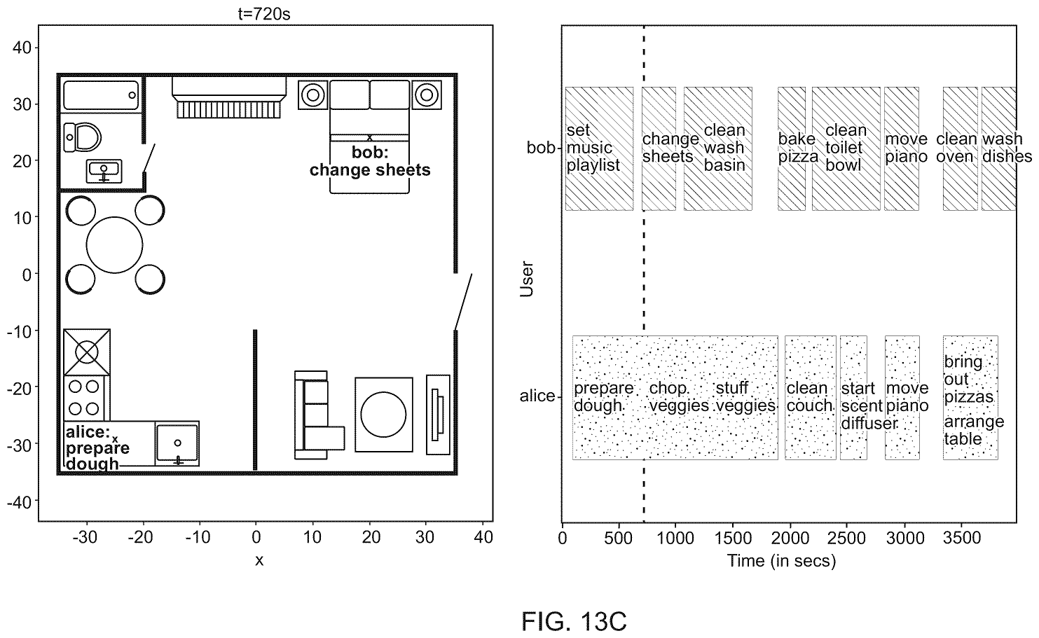

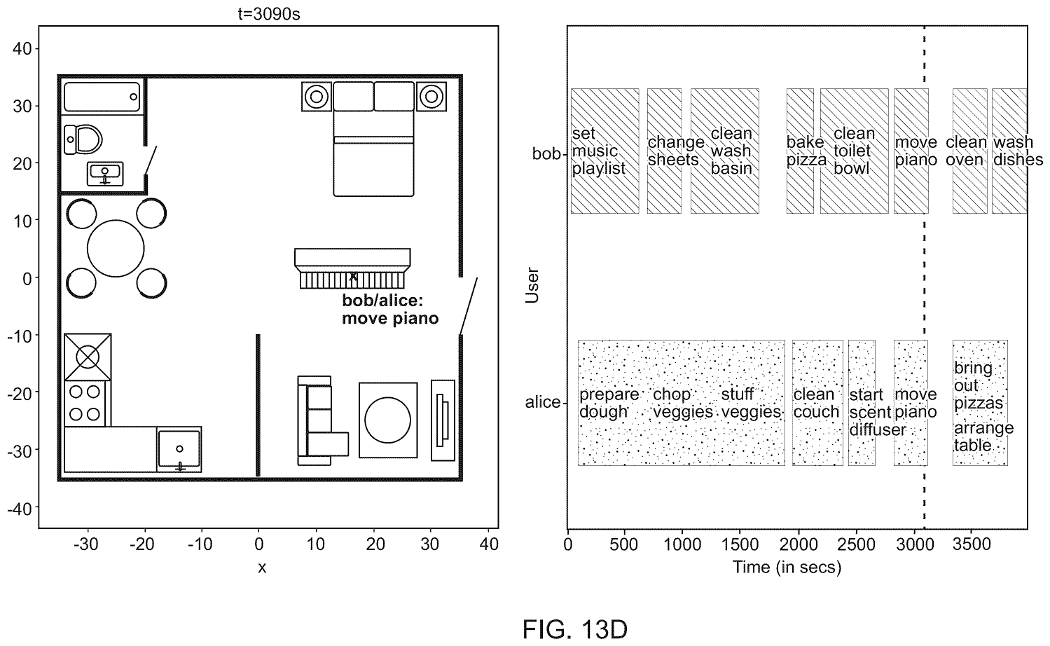

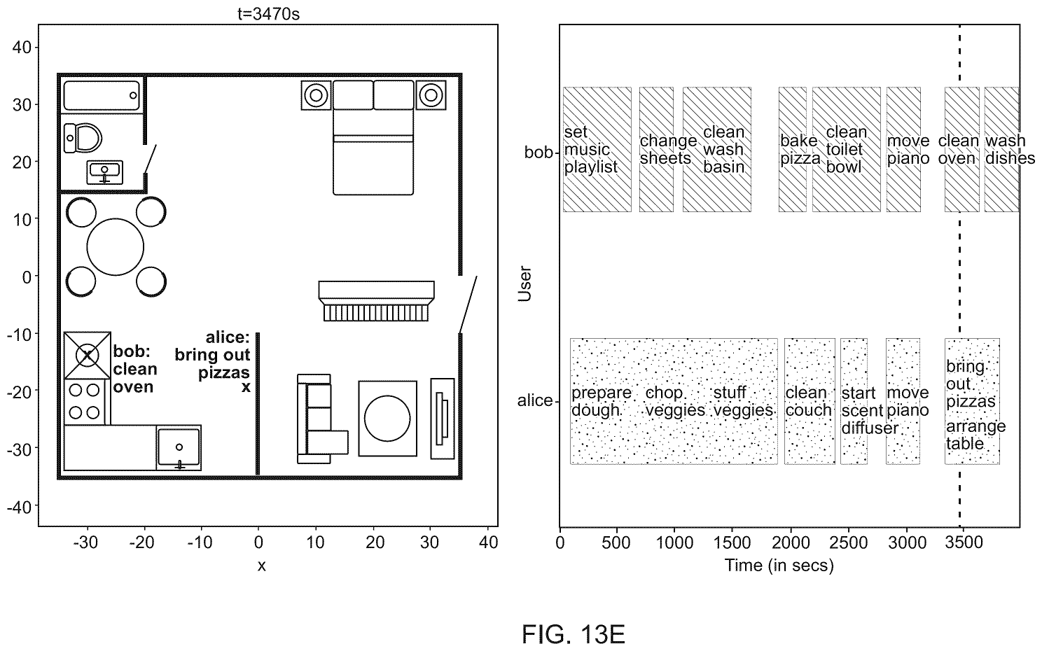

Initially, a simple case was demonstrated using the planner for two users Alice and Bob planning to accomplish five tasks. FIG. 13A summarizes the tasks allocated to each user along with their sequence of execution and start and end times. Note that moving a piano requires collaboration from both Alice and Bob and is reflected accordingly in both their timelines and in the spatial map visualization (FIG. 13B). Further, the black arrow in the spatial map corresponds to the motion of the piano from the task's start location to its end location. Other tasks do not have different start and end locations; hence they appear as black points in the spatial map. FIGS. 13C-13E show a simple two-dimensional visualization of the two users (Alice and Bob) coordinating their chores in a small house using the multiuser version of the task scheduler. The left hand-side shows a spatial visualization of the users' paths and the tasks as they happen. The right-hand side graph shows the allocation of tasks to users and a visualization of the temporal schedule for each user as they perform the tasks.

### A More Complex Case

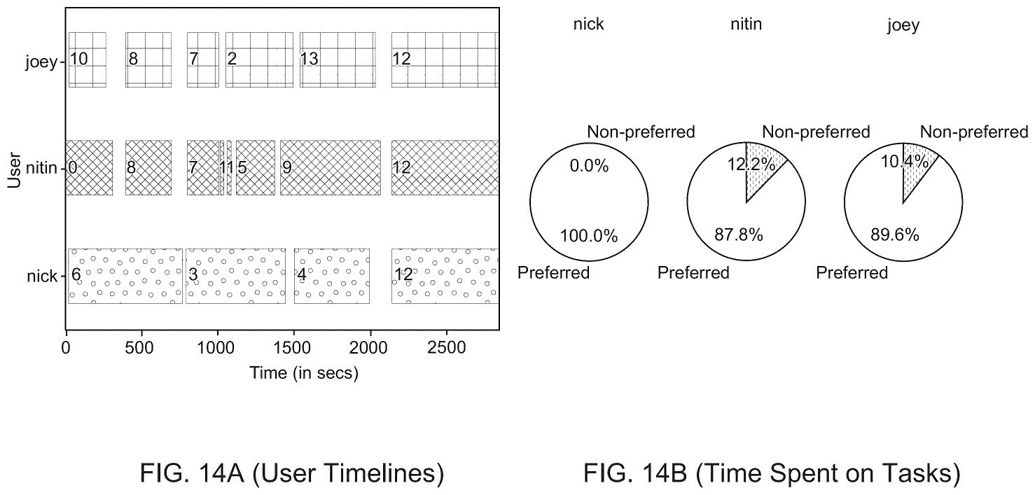

Secondly, a more complex case was demonstrated using the planner for three users (Nick, Nitin and Joey), fourteen tasks and many temporal, allocation and capacity constraints are visualized in FIGS. 14A and 14B. Since this is a more complex planning task, the best feasible solution found after 10 seconds of planning was presented. A timeline visualization of the task allocation is presented in FIG. 14A. Note that tasks 7 and 8 require collaboration from two users, while task 12 requires all three users. The spatial map is not provided here since it gets very cluttered with many users and tasks. Further, FIG. 14B captures the amount of time each user spent on tasks they prefer versus the ones they don't. In this case, one of the users (Nitin) had to spend some time on non-preferred tasks in favor of completing the full plan earlier.

### A Replanning Case

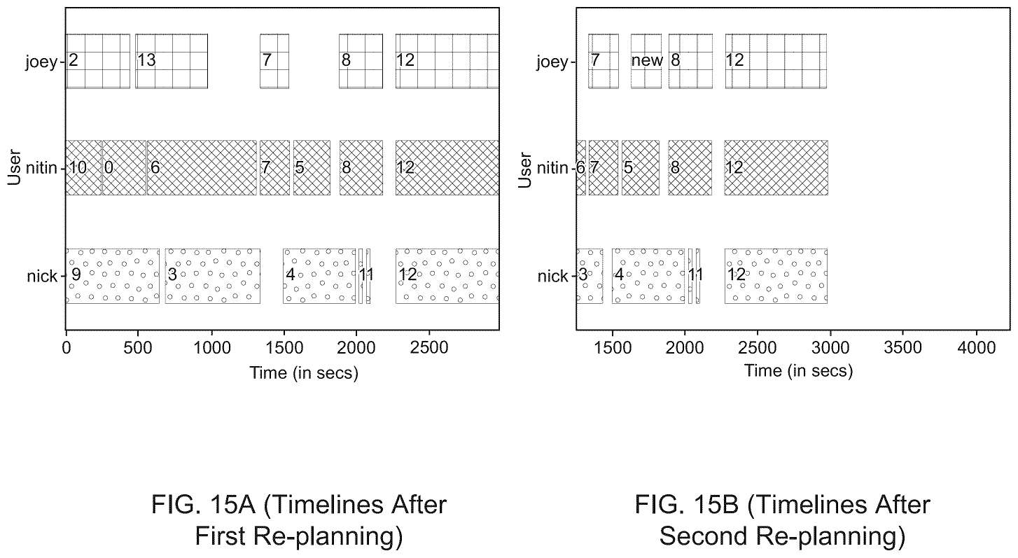

Lastly, a case was demonstrated using the planner for two re-plannings. The first input enforces that Nitin, Joey and Nick are in the middle of tasks 10, 2 and 9 respectively at time t0=0, which is reflected by their immediate execution in their timelines shown in FIG. 15A. FIG. 15B shows a second re-planning starting from the new time t0=1250 seconds. From FIG. 15A, it can be observed that Nick and Nitin are in the middle of tasks 3 and 6 respectively, which are enforced to continue with their remaining durations in FIG. 15B after the second re-planning. Note that a new task (with ID “new”) was also requested to be scheduled and it has been fit into Joey's plan in FIG. 15B.

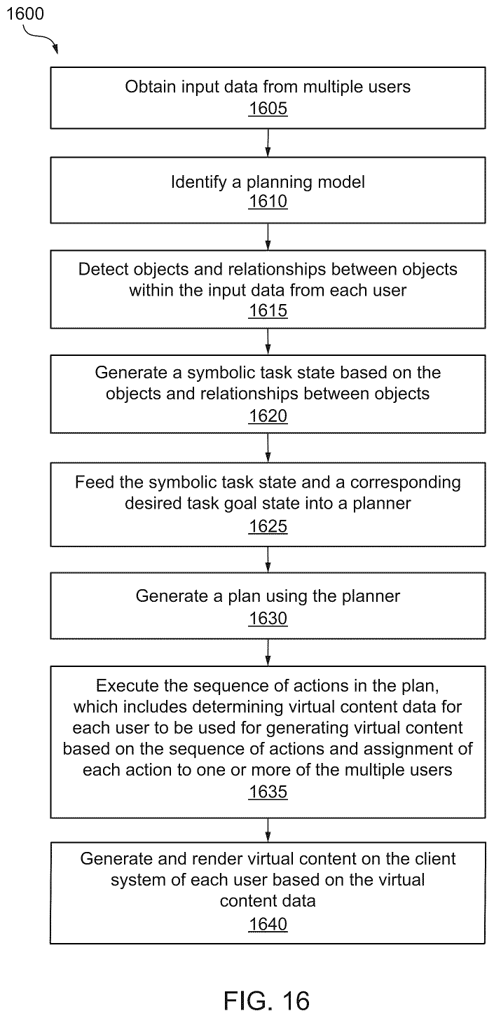

FIG. 16 is a flowchart illustrating a process 1600 for assigning actions to assist users with performing a task and achieving a goal according to various embodiments. The processing depicted in FIG. 16 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 16 and described below is intended to be illustrative and non-limiting. Although FIG. 16 depicts the various processing steps occurring in a particular sequence or order, this is not intended to be limiting. In certain alternative embodiments, the steps may be performed in some different order or some steps may also be performed in parallel. In certain embodiments, such as in an embodiment depicted in FIGS. 1, 2A, 2B, 3A, 3B, 4A, 4B, 4C, and 5, the processing depicted in FIG. 16 may be performed by a client system implementing a virtual assistant to assign actions to assist users with performing a task and achieving a goal.

At step 1605, input data is obtained from multiple users. The input data includes: (i) data regarding activity of each user in an extended reality environment (e.g., images and audio of the user interacting in the physical environment and/or the virtual environment), (ii) data from external systems, or (iii) both. The data regarding activity of at least one of the users in an extended reality environment includes an explicit or implicit request by at least one of the users for assistance in performing a task (e.g., baking a pizza). The input data may be obtained by a client system associated with each user that comprises at least a portion of the virtual assistant. In certain instances, the client systems are HMDs as described in detail herein. In some instances, the data regarding activity of each user includes a sequence of perceptions from the egocentric vision of each user.

At step 1610, a planning model for the task is identified from a corpus of planning models for various tasks. The planning model for the task is expressed with the domain specific planning language, and the planning model encodes the actions for the task and how the actions impact objects and the relationships between objects.

At step 1615, objects and relationships between the objects within the input data are detected using one or more computer vision object detector models (object detection models). The objects and relationships between the objects pertain to the task. The one or more object detector models may be one or more machine learning models such as a CNN, a R-CNN, a fast R-CNN, a faster R-CNN, a Mask R-CNN, a You Only Look Once (YOLO), Detectron, Detectron2, or any combination or variant thereof. The object detection comprises extracting object features from the input data for the task, locating the presence of objects with a bounding box and assigning labels to types or classes of the located objects and relationships between the located objects based on the extracted object features. The one or more object detection models output the labels to types or classes of the located objects and relationships between the objects. The labels for the objects and relationships between objects are a set of state variables that are propositional in nature (propositional variables) for the current state of the world as observed by the user.

At step 1620, a symbolic task state is generated based on the objects and the relationships between the objects. The generating the symbolic task state comprises describing an association of the objects and object relationships with the perceptual features (the labels) as logical statements (e.g., Boolean expressions). The logical statements may comprise: values (YES and NO, and their synonyms, ON and OFF, TRUE and FALSE, etc.), variables or formulas, functions that yield results, and values calculated by comparison operators.

At step 1625, the symbolic task state and a corresponding desired task goal state are fed into a planner using the domain specific planning language. The corresponding desired task goal state is a state that the objects and the relationships between the objects must take in order for the task to be considered completed.

At step 1630, a plan is generated using the planner. The plan includes a sequence of actions to perform the task and achieve the corresponding desired task goal. The sequence of actions optimizes for one or more metrics while respecting constraints, costs, and preferences for the task. The constraints include a requirement for allocating the actions from the sequence of actions amongst the multiple users. In some instances, the sequence of actions is a temporal ordering of the actions, and each action is assigned to one or more of the multiple users. A number of the multiple users is used as a constraint in solving the temporal planning problem and the task allocation problem. In some instances, task preferences for each of the multiple users are used as preferences in solving the temporal planning problem and the task allocation problem.

At step 1635, the sequence of actions in the plan is executed in accordance with the temporal ordering, duration of the actions, and assignment of each action to one or more of the multiple users. The executing the sequence of actions comprises determining virtual content data to be used for rendering virtual content based on the sequence of actions. The actions are associated with virtual content data defined and coded for the actions in order to assist each user with performing the task and achieving the goal. Determining the virtual content data comprises mapping the actions to respective action spaces and determining the virtual content data associated with the respective actions spaces. The executing the sequence of actions further comprises assigning the virtual content data to each user based on the assignment of each action to the one or more of the plurality of users. Assigning the virtual content data comprises identifying unique user identifiers associated with the actions, imputing the unique user identifiers associated with each action to the virtual content data determined respectively for each action, mapping each unique user identifier associated with the virtual content data to the client systems associated with each corresponding user, and communicating the virtual content data to the client systems in accordance with the mappings.

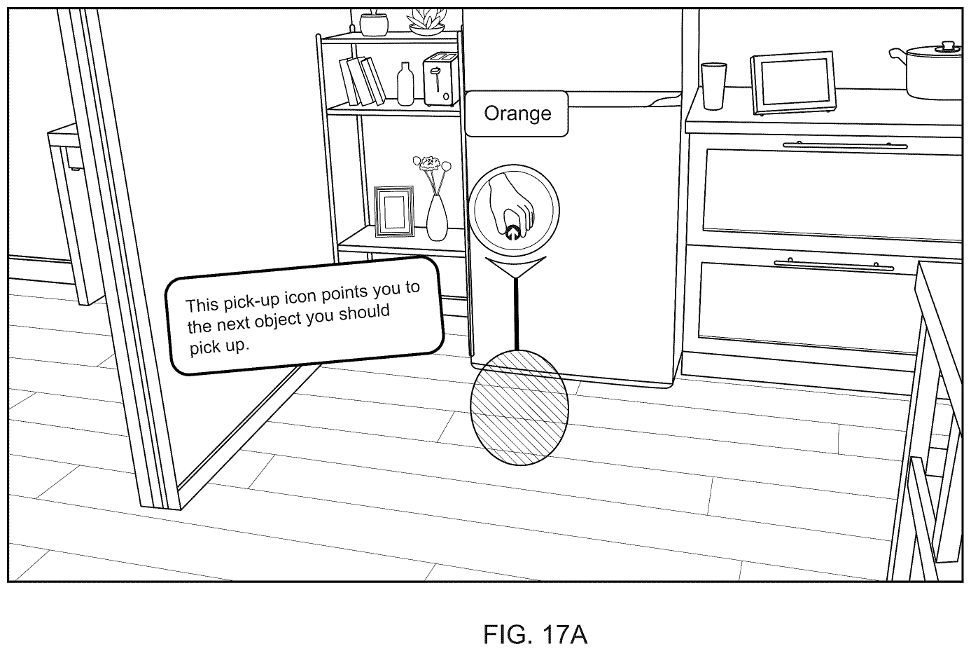

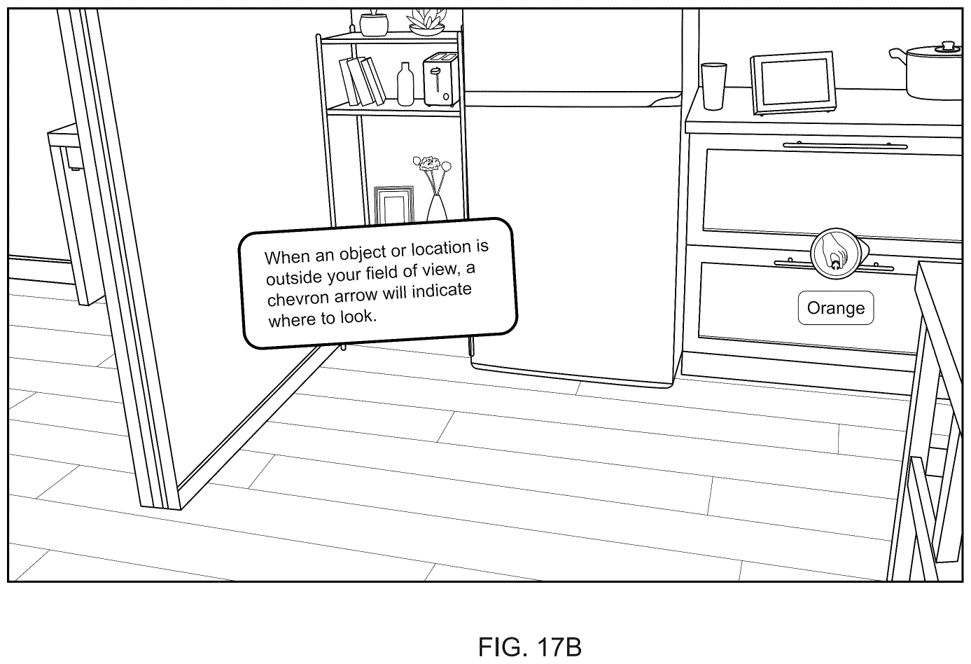

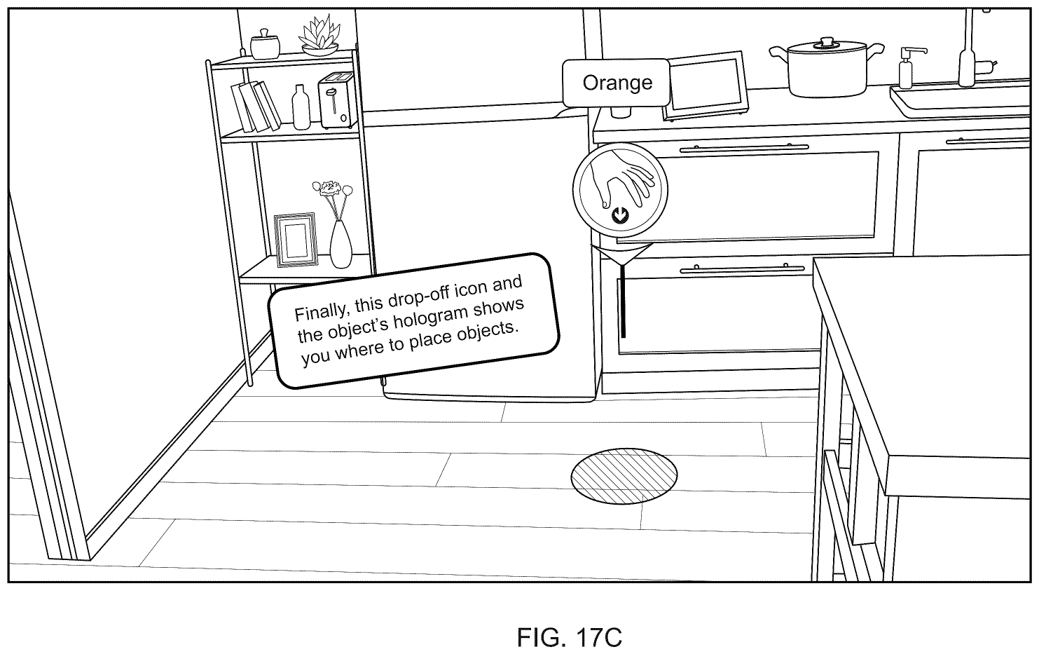

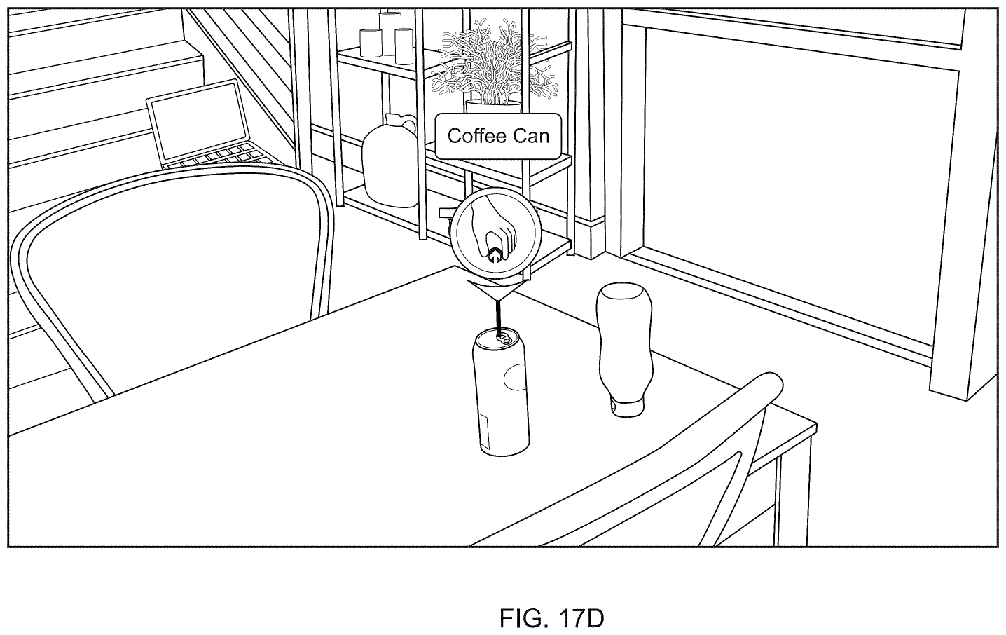

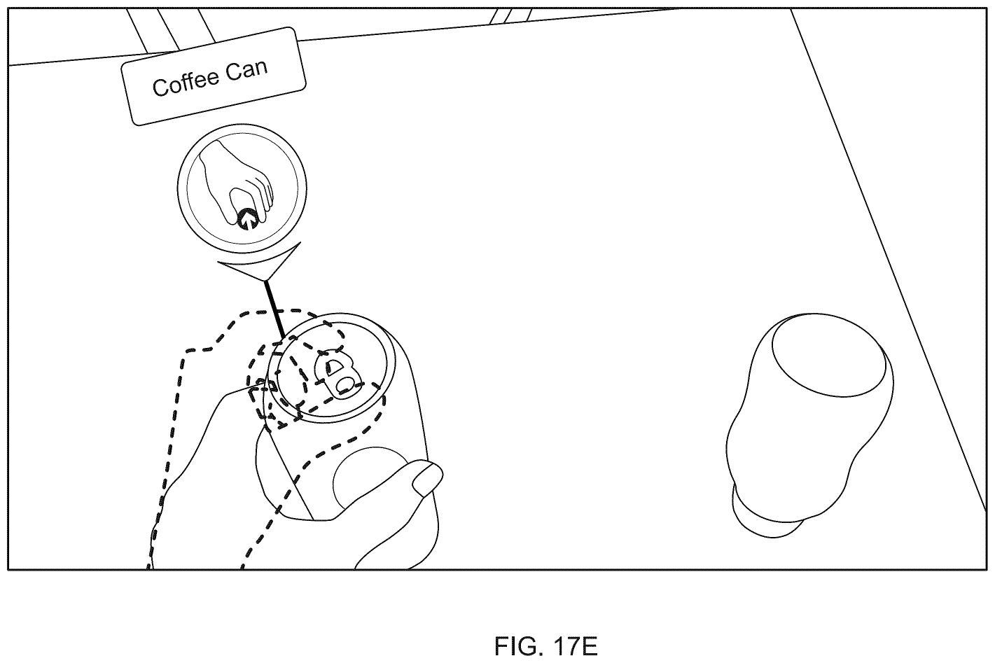

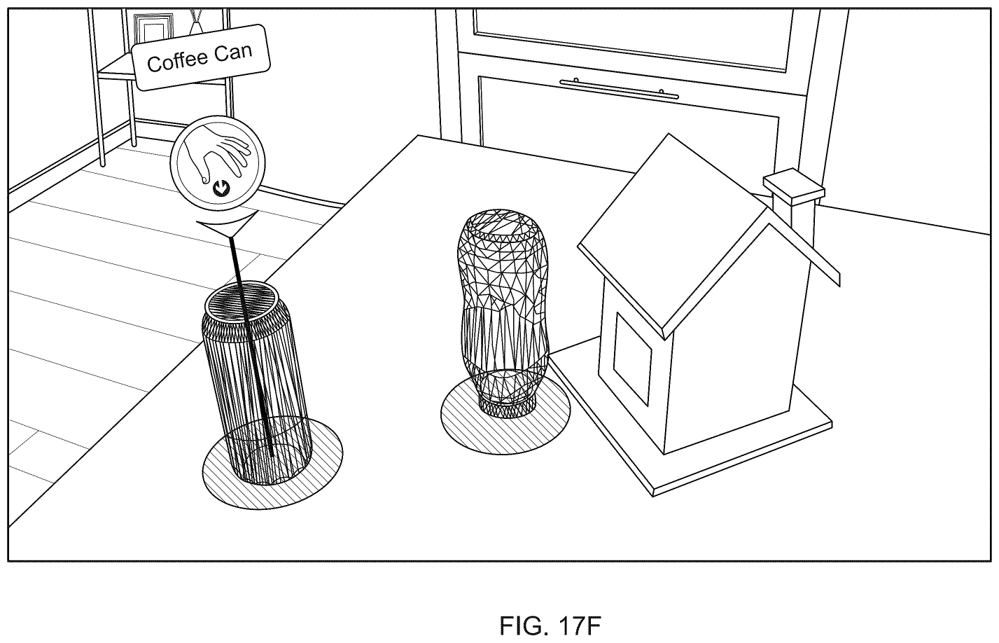

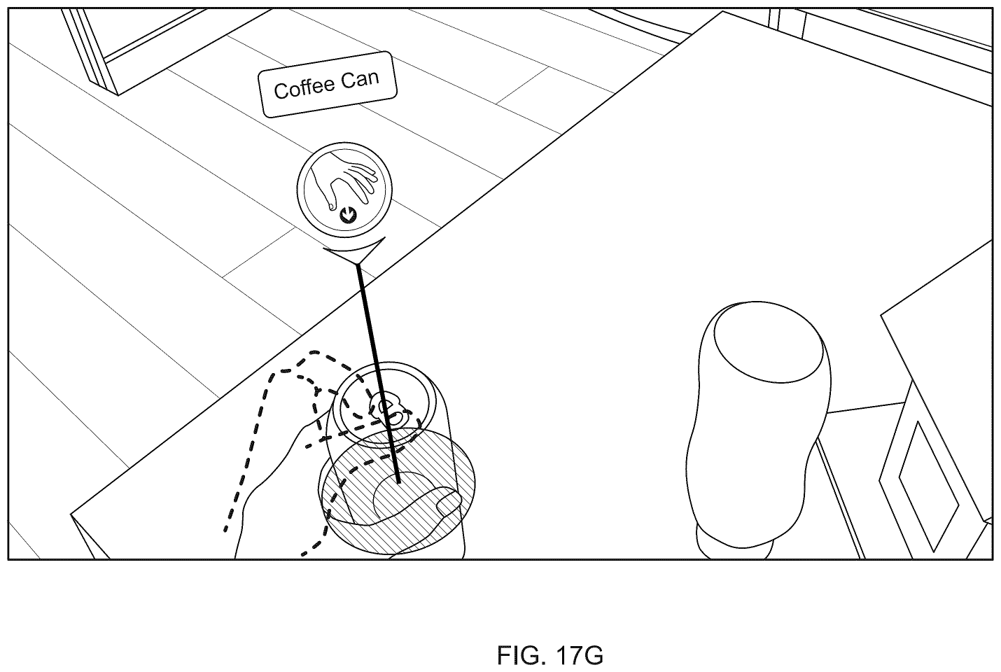

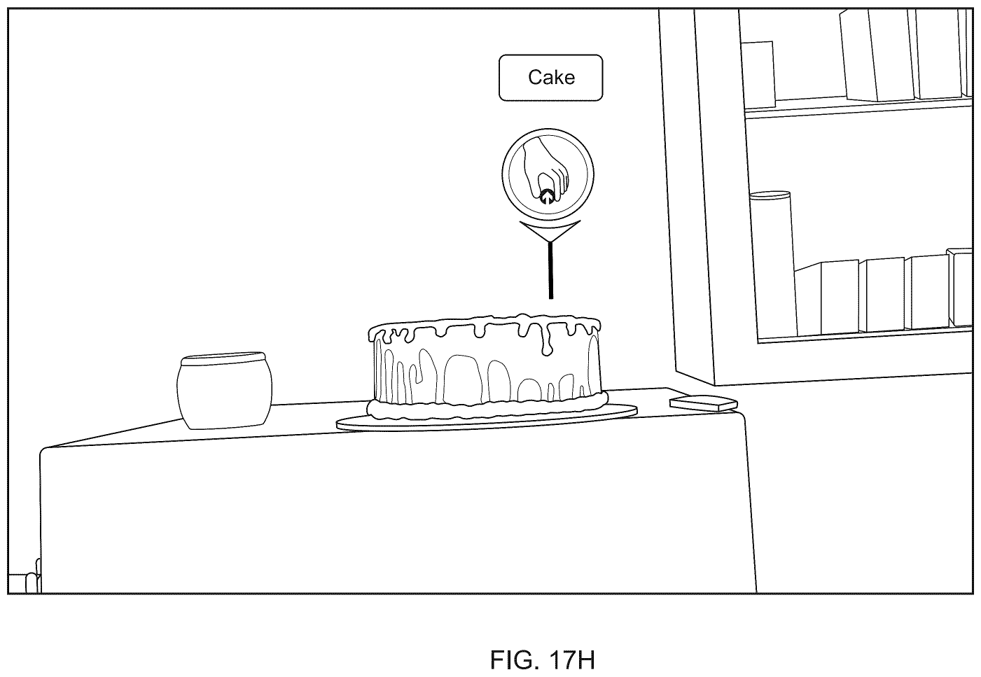

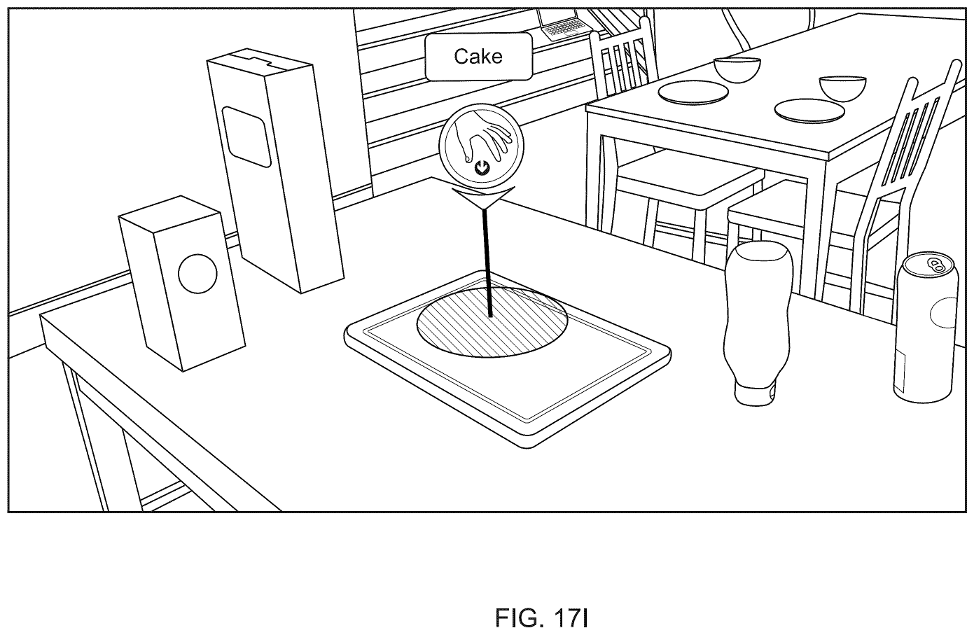

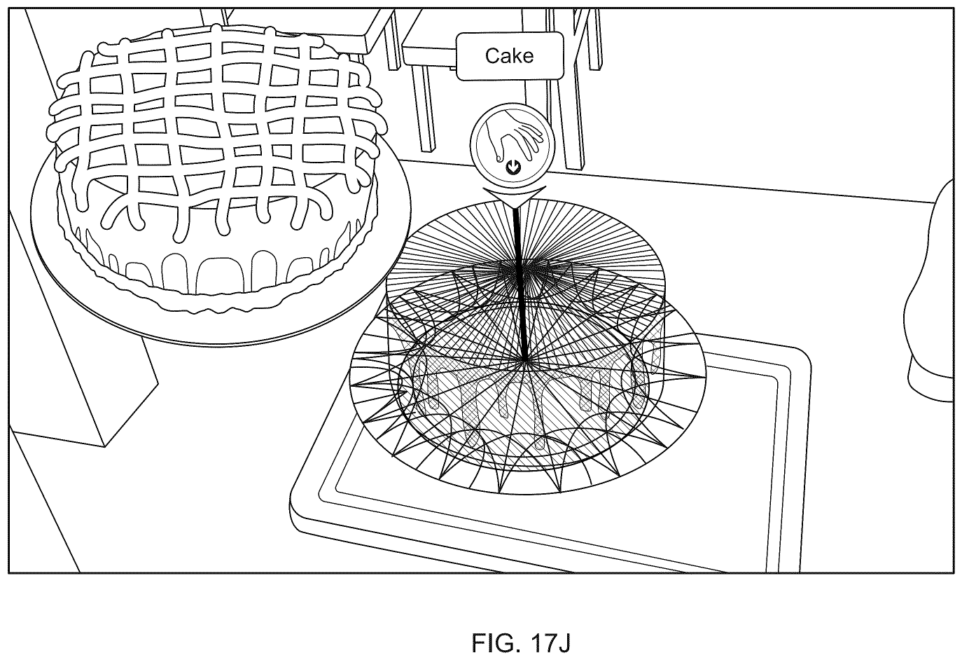

At step 1640, the virtual content is generated and rendered, by the client system associated with each user, in the extended reality environment displayed to each user respectively based on the virtual content data communicated to each client system by the virtual assistant. The virtual content is used by the client system of each user to present, initiate, or execute actions from the sequence of actions for each user respectively. FIGS. 17A-17J show an actual three-dimensional demo of a user performing tasks using the task scheduler. The tasks were performed using an HMD in augmented reality while the optimal guide (virtual assistant) gave the user instructions on how to optimally perform the tasks. FIGS. 17A-17C show a quick tutorial from the optimal guide providing a mock-up of the optimal guide UI elements (virtual content) and how a user may interact with the UI elements. FIGS. 17D-17J show a user performing the task of preparing for a party in time including subtasks of cleaning up and preparing a snack. FIGS. 17D-17G shows the user being directed with the optimal guide UI elements to put away a coffee can and bottle of jam (from table to kitchen counter). FIGS. 17H-17J shows the user being directed with the optimal guide UI elements to serve a cake for consumption as a snack at the party.

The processes described with respect to steps 1605-1640 may be executed every few frames of input data, in order for the overall virtual assistance to be replanned and adapted dynamically or on the fly based on the actions of the user in the artificial virtual environment.

### Additional Considerations

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. An extended reality system comprising:
a head-mounted device comprising a display to display content to a user and one or more cameras to capture images of a visual field of the user wearing the head-mounted device;
one or more processors; and
one or more memories accessible to the one or more processors, the one or more memories storing a plurality of instructions executable by the one or more processors, the plurality of instructions comprising instructions that when executed by the one or more processors cause the one or more processors to perform processing comprising:
obtaining input data from the one or more cameras, the input data including video captured by the one or more cameras;
detecting, from the input data, objects and relationships between the objects for performing a task;
generating a symbolic task state based on the objects and the relationships between the objects;
feeding, using a domain specific planning language, the symbolic task state and a corresponding desired task goal state into a planner;
generating, using the planner, a plan that includes a sequence of actions to perform the task and achieve the corresponding desired task goal, wherein the sequence of actions optimize for one or more metrics while respecting constraints, costs, and preferences for the task; and
in response to executing the sequence of actions in the plan, rendering, on the display, virtual content in an extended reality environment.

2. The system of claim 1, wherein:
the input data further includes a request by the user for assistance in performing the task;
the objects and relationships between the objects pertain to the task; and
the corresponding desired task goal state is a state that the objects and the relationships between the objects must take in order for the task to be considered completed.

3. The system of claim 2, wherein the processing further comprises identifying a planning model for the task from a corpus of planning models for various tasks, wherein the planning model for the task is expressed with the domain specific planning language, and wherein the planning model encodes the actions for the task and how the actions impact the objects and the relationships between the objects.

4. The system of claim 1, wherein detecting the objects and the relationships between the objects comprises extracting object features from the input data, locating a presence of the objects with a bounding box and assigning labels to types or classes of the located objects and relationships between the located objects based on the extracted object features, and wherein the labels for the located objects and the relationships between the located objects are a set of state variables that are propositional in nature for the symbolic task state as observed by the user, and generating the symbolic task state comprises describing an association of the objects and the relationships between the objects with the labels as logical statements.

5. The system of claim 1, wherein the rendering comprises:
executing at least some of the sequence of actions in the plan, wherein the executing comprises determining virtual content data to be used for rendering the virtual content based on the sequence of actions, and wherein determining the virtual content data comprises mapping the actions to respective action spaces and determining the virtual content data associated with the respective action spaces; and
rendering the virtual content in the extended reality environment displayed to the user based on the virtual content data, wherein the virtual content presents instructions or recommendations to the user for performing at least some of the sequence of actions based on the plan.

6. The system of claim 1, further comprising a plurality of head-mounted devices including the headed-mounted device of the user, wherein each of the plurality of headed-mounted devices comprises a display to display content to a different user and one or more cameras to capture images of a visual field of the different user wearing the head-mounted device, and wherein:
the input data is obtained from the one or more cameras from each of the plurality of head-mounted devices;
the constraints include a requirement for allocating the actions from the sequence of actions amongst the user and each of the different users; and
in response to executing the sequence of actions in the plan, the virtual content is rendered in the extended reality environment on the display of the user and each of the different users, and the virtual content rendered for the user and each of the different users is specific to the actions allocated for the user and each of the different users from the sequence of actions.

7. The system of claim 1, wherein the input data includes: (i) data regarding activity of the user in the extended reality environment, (ii) data from external systems, or (iii) both, and the data regarding activity of the user includes the video.

8. A computer-implemented method comprising:
obtaining input data from one or more cameras of a head-mounted device, the input data including video captured by the one or more cameras;
detecting, from the input data, objects and relationships between the objects for performing a task;
generating a symbolic task state based on the objects and the relationships between the objects;
feeding, using a domain specific planning language, the symbolic task state and a corresponding desired task goal state into a planner;
generating, using the planner, a plan that includes a sequence of actions to perform the task and achieve the corresponding desired task goal, wherein the sequence of actions optimize for one or more metrics while respecting constraints, costs, and preferences for the task; and
in response to executing the sequence of actions in the plan, rendering, on a display of the head-mounted device, virtual content in an extended reality environment.

9. The computer-implemented method of claim 8, wherein:
the input data further includes a request by the user for assistance in performing the task;
the objects and relationships between the objects pertain to the task; and
the corresponding desired task goal state is a state that the objects and the relationships between the objects must take in order for the task to be considered completed.

10. The computer-implemented method of claim 9, further comprising identifying a planning model for the task from a corpus of planning models for various tasks, wherein the planning model for the task is expressed with the domain specific planning language, and wherein the planning model encodes the actions for the task and how the actions impact the objects and the relationships between the objects.

11. The computer-implemented method of claim 8, wherein detecting the objects and the relationships between the objects comprises extracting object features from the input data, locating a presence of the objects with a bounding box and assigning labels to types or classes of the located objects and relationships between the located objects based on the extracted object features, and wherein the labels for the located objects and the relationships between the located objects are a set of state variables that are propositional in nature for the symbolic task state as observed by the user, and generating the symbolic task state comprises describing an association of the objects and the relationships between the objects with the labels as logical statements.

12. The computer-implemented method of claim 8, wherein the rendering comprises:
executing at least some of the sequence of actions in the plan, wherein the executing comprises determining virtual content data to be used for rendering the virtual content based on the sequence of actions, and wherein determining the virtual content data comprises mapping the actions to respective action spaces and determining the virtual content data associated with the respective action spaces; and
rendering the virtual content in the extended reality environment displayed to the user based on the virtual content data, wherein the virtual content presents instructions or recommendations to the user for performing at least some of the sequence of actions based on the plan.

13. The computer-implemented method of claim 8, wherein:
the input data is obtained from one or more cameras from each of a plurality of head-mounted devices including the headed-mounted device of the user;
each of the plurality of headed-mounted devices comprises a display to display content to a different user and the one or more cameras to capture images of a visual field of the different user wearing the head-mounted device
the constraints include a requirement for allocating the actions from the sequence of actions amongst the user and each of the different users; and
in response to executing the sequence of actions in the plan, the virtual content is rendered in the extended reality environment on the display of the user and each of the different users, and the virtual content rendered for the user and each of the different users is specific to the actions allocated for the user and each of the different users from the sequence of actions.

14. The computer-implemented method of claim 8, wherein the input data includes: (i) data regarding activity of the user in the extended reality environment, (ii) data from external systems, or (iii) both, and the data regarding activity of the user includes the video.

15. A non-transitory computer-readable memory storing a plurality of instructions executable by one or more processors, the plurality of instructions comprising instructions that when executed by the one or more processors cause the one or more processors to perform the following operations:
obtaining input data from one or more cameras of a head-mounted device, the input data including video captured by the one or more cameras;
detecting, from the input data, objects and relationships between the objects for performing a task;
generating a symbolic task state based on the objects and the relationships between the objects;
feeding, using a domain specific planning language, the symbolic task state and a corresponding desired task goal state into a planner;
generating, using the planner, a plan that includes a sequence of actions to perform the task and achieve the corresponding desired task goal, wherein the sequence of actions optimize for one or more metrics while respecting constraints, costs, and preferences for the task; and
in response to executing the sequence of actions in the plan, rendering, on a display of the head-mounted device, virtual content in an extended reality environment.

16. The non-transitory computer-readable memory of claim 15, wherein:
the input data further includes a request by the user for assistance in performing the task;
the objects and relationships between the objects pertain to the task; and
the corresponding desired task goal state is a state that the objects and the relationships between the objects must take in order for the task to be considered completed.

17. The non-transitory computer-readable memory of claim 16, wherein the operations further comprise identifying a planning model for the task from a corpus of planning models for various tasks, wherein the planning model for the task is expressed with the domain specific planning language, and wherein the planning model encodes the actions for the task and how the actions impact the objects and the relationships between the objects.

18. The non-transitory computer-readable memory of claim 15, wherein detecting the objects and the relationships between the objects comprises extracting object features from the input data, locating a presence of the objects with a bounding box and assigning labels to types or classes of the located objects and relationships between the located objects based on the extracted object features, and wherein the labels for the located objects and the relationships between the located objects are a set of state variables that are propositional in nature for the symbolic task state as observed by the user, and generating the symbolic task state comprises describing an association of the objects and the relationships between the objects with the labels as logical statements.

19. The non-transitory computer-readable memory of claim 15, wherein the rendering comprises:
executing at least some of the sequence of actions in the plan, wherein the executing comprises determining virtual content data to be used for rendering the virtual content based on the sequence of actions, and wherein determining the virtual content data comprises mapping the actions to respective action spaces and determining the virtual content data associated with the respective action spaces; and
rendering the virtual content in the extended reality environment displayed to the user based on the virtual content data, wherein the virtual content presents instructions or recommendations to the user for performing at least some of the sequence of actions based on the plan.

20. The non-transitory computer-readable memory of claim 15, wherein:
the input data is obtained from one or more cameras from each of a plurality of head-mounted devices including the headed-mounted device of the user;
each of the plurality of headed-mounted devices comprises a display to display content to a different user and the one or more cameras to capture images of a visual field of the different user wearing the head-mounted device
the constraints include a requirement for allocating the actions from the sequence of actions amongst the user and each of the different users; and
in response to executing the sequence of actions in the plan, the virtual content is rendered in the extended reality environment on the display of the user and each of the different users, and the virtual content rendered for the user and each of the different users is specific to the actions allocated for the user and each of the different users from the sequence of actions.
